(19) United States
(12) Patent Application Publication
(10) Pub. No.: US 2024/0020160 A1
(43) Pub. Date: Jan. 18, 2024

(54) VIRTUAL FLATSAT AND DISTRIBUTED DIGITAL NODES

(71) Applicant: Antaris, Inc., Los Altos, CA (US)

(72) Inventors: Sivakumar Govindassamy, Los Altos, CA (US); Karthikeyan Govindhasamy, Los Altos, CA (US); N.M. Prakash, Los Altos, CA (US)

(21) Appl. No.: 18/222,139

(22) Filed: Jul. 14, 2023

Related U.S. Application Data
(60) Provisional application No. 63/389,320, filed on Jul. 14, 2022.

(51) Int. Cl. G06F 9/50

(52) U.S. Cl. CPC G06F 9/5027

(57) ABSTRACT

Methods and systems are provided to enable a virtual FlatSat and distributed node architecture. The virtual platform may be or include a SaaS platform that enables multiple users to access computing nodes. The computing nodes may enable the users to test hardware sub-systems by connecting to the SaaS through a remote computer, or to test virtual hardware on the SaaS platform without use of the remote computer. Testing of physical or virtual hardware sub-systems on the remote computer may include application API execution that mimics local software, reducing the likelihood of failed testing of the hardware sub-systems.

### CROSS REFERENCE TO RELATED APPLICATIONS

The present application claims the benefits of and priority, under 35 U.S.C. § 119(e), to U.S. Provisional Application Ser. No. 63/389,320, filed on Jul. 14, 2022, entitled “VIRTUAL FLATSAT AND DISTRIBUTED DIGITAL NODES.” The entire disclosure of the application listed above is hereby incorporated by reference, in its entirety, for all that it teaches and for all purposes.

### FIELD

The present disclosure is generally directed to distributed processing systems and distributed processing nodes.

### SUMMARY

The various embodiments and configurations of the present disclosure address needs in the related art.

The present disclosure provides, among other things, distributed digital nodes and virtualization techniques.

The present disclosure can provide a number of advantages depending on the particular configuration.

These and other advantages will be apparent from the disclosure contained herein.

A system for a satellite according to at least one embodiment of the present disclosure comprises: at least one resource that communicates with a payload of the satellite, the at least one resource including a first abstracted physical communication interface; and a controller coupled to the at least one resource and including a second abstracted physical communication interface that communicates with the first abstracted physical communication interface over a communications link.

Any of the features herein, wherein the communications link comprises a USB connection, a UART connection, an Ethernet connection, an SPI connection, a PCI connection, a physical interface, a wireless interface, and/or an I2C connection.

Any of the features herein, wherein the at least one resource includes a payload server, an edge server, a compute resource, and/or a compute node.

Any of the features herein, wherein the compute node is a client node or a server node.

Any of the features herein, wherein the controller includes a third abstracted physical communication interface that communicates with a remote node.

Any of the features herein, wherein the at least one resource comprises an IPCC message encoder/decoder module, an IPCC message payload security module, and a bridge module that routes a message received over the communications link to the controller.

Any of the features herein, wherein a remote node is accessible by a primary user and by a secondary user.

Any of the features herein, wherein the bridge module manages the accessibility of the primary user and the secondary user, and wherein the primary user comprises one or more users.

Any of the features herein, wherein the at least one resource comprises a second remote node, wherein the bridge module associates the primary user with the remote node, and wherein the bridge module associates the secondary user with the second remote node.

Any of the features herein, wherein the remote node and the second remote node are remote to the at least one resource and the controller.

Any of the features herein, wherein a first simulation of the system comprises the at least one resource and the controller, wherein a second simulation of the system comprises at least one second resource and a second controller, wherein the primary user accesses the first simulation, and wherein the secondary user accesses the second simulation.

Any of the features herein, wherein the at least one resource comprises a simulation adaption layer.

Any of the features herein, wherein an Internet Protocol (IP) connectivity of the simulation adaption layer is configurable.

Any of the features herein, wherein the first abstracted physical communication interface and the second abstracted communication interface communicate with one another according to at least one of Internet Protocol (IP), TCP, UDP, and a direct API.

Any of the features herein, wherein the at least one resource includes two or more of a payload server, an edge server, a compute resource, and a compute node.

Any of the features herein, wherein the edge server and the payload server communicate with one another according to at least one of Internet Protocol (IP), TCP, UDP, and a direct API.

Any of the features herein, wherein the controller and/or the at least one resource selects an application programming interface (API) used for presenting data to a user.

Any of the features herein, wherein the controller and/or the at least one resource convert a request for an API into a JSON file and/or convert a JSON file into an API.

Any of the features herein, wherein the controller and/or the at least one resource convert a second request for a second API into a second JSON file and/or convert a second JSON file into a second API.

Any of the features herein, wherein the request and the second request are delivered asynchronously.

Any of the features herein, wherein the second request is delivered synchronously after a confirmation of the conversion of the request is received at the controller and/or at the at least one resource.

Any of the features herein, wherein the controller and/or the at least one resource adds API execution timing constraints in the JSON file while converting.

Any of the features herein, wherein the controller and/or the at least one resource convert a request for an API into a file and/or convert a file into an API, and wherein the controller and/or the at least one resource adds API execution timing constraints in the file while converting.

Any of the features herein, wherein the API execution timing constraints specify that the API is to be executed a predetermined time after a second API is executed.

Any of the features herein, wherein the API execution timing constraints specify that the API is to be executed a predetermined time before a second API is executed.

Any of the features herein, wherein the API execution timing constraints specify that the API is to be executed at the same time as a second API.

Any of the features herein, wherein the API execution timing constraints specify that the API is to be executed at a predetermined time.

Any of the features herein, wherein the converting is performed at least partially by a simulation adaption layer.

Any of the features herein, wherein the file comprises a JSON file, a text file, a Protocol Buffer, or a csv file.

Any of the features herein, wherein the file specifies an anticipated response format from the payload.

Any of the features herein, wherein the anticipated response format includes an expected time for response from the payload.

Any of the features herein, wherein an error message is generated when a payload response time is greater than the expected time.

Any of the features herein, wherein the at least one resource executes the API a predetermined number of times when a payload response time is greater than the expected time.

Any of the features herein, wherein the file comprises a plurality of parameters specifying the API execution.

Any of the features herein, wherein the plurality of parameters comprises two or more of a data type, a data length, a relative execution time, an API type, an API name, a number of arguments, and an execution mode.

Any of the features herein, wherein the API execution uses data previously sent to and stored on the at least one resource.

Any of the features herein, wherein the controller and/or the at least one resource adds one or more dependency API details in the JSON file while converting.

Any of the features herein, wherein the at least one resource executes one or more applications for interacting with the payload.

Any of the features herein, wherein each of the one or more applications is associated with a different address.

Any of the features herein, wherein each different address comprises an IP address.

Any of the features herein, wherein communication between the first abstracted physical communication interface and the one or more applications comprises IP communication and/or an inter process communication (IPC) message.

Any of the features herein, wherein communication between the second abstracted physical communication interface and one or more applications running on the controller comprises inter thread communication.

Any of the features herein, wherein the at least one resource further comprises: an encoder/decoder module, a security module, a registration module, a router module, and a listener/sender module.

Any of the features herein, wherein each application executable at the at least one resource is assigned a unique application ID.

Any of the features herein, wherein messages exchanged between the at least one resource and the controller comprise a header that includes the application ID.

Any of the features herein, wherein the header for each message further comprises a source hardware device ID, a destination hardware device ID, a field that enables and disables encryption/decryption, a field that enables authentication, and/or a packet sequence number.

Any of the features herein, wherein, for incoming messages from the controller to the at least one resource, the at least one resource processes the header before sending the incoming messages to an application of the at least one resource.

Any of the features herein, wherein, for outgoing messages from the at least one resource to the controller, the at least one resource adds the header to the outgoing messages before sending to the controller.

Any of the features herein, wherein application hardware sub-systems of the payload are remote to the at least one resource and the controller.

Any of the features herein, wherein data from the application hardware sub-systems is stored locally before being sent to the at least one resource and/or the controller.

Any of the features herein, wherein the application hardware sub-systems are tested in a virtual environment using the at least one resource.

Any of the features herein, wherein the application hardware sub-systems, the at least one resource, and the controller are cloud-based.

Any of the features herein, wherein the at least one resource and the controller are cloud-based.

Any of the features herein, further comprising: the satellite, wherein the satellite includes the at least one resource and the controller.

Any of the features herein, wherein the at least one resource comprises a computing node simulated in a cloud server, a computing resource simulated in a cloud server, a desktop computer, and a high-performance computing (HPC) device.

Any of the features herein, wherein the at least one resource corresponds to a computing node, computing resource execution, a sensor hardware subsystem simulated in a cloud server, a sensor hardware subsystem simulated in a desktop computer, a sensor hardware subsystem simulated in a high-performance computing (HPC) device, and/or a satellite payload hardware subsystem.

A method of simulating collection of satellite data according to at least one embodiment of the present disclosure comprises: providing at least one cloud-based computing node for controlling a payload of a satellite; providing at least one remote computing node including an application hardware sub-system that simulates the payload of the satellite; and simulating operation of the payload of satellite using the application hardware sub-system based on signals received by the at least one remote computing node from the at least one cloud-based computing node.

Any of the features herein, wherein the application hardware sub-system comprises a sensor that is simulated by software of the at least one remote computing node.

Any of the features herein, wherein the application hardware sub-system comprises a physical sensor that is separate from but in communication with the at least one remote computing node.

A system according to at least one embodiment of the present disclosure comprises: three or more distributed computes that interact with one another in a cloud environment and at least one of which is in communication with a remote resource via a cloud connection, wherein each of the three or more distributed computes are configured to receive information from the remote resource and/or provide commands executable by the remote resource.

Any of the features herein, wherein the remote resource comprises a simulated resource.

Any of the features herein, wherein the simulated resource comprises a simulated sensor.

Any of the features herein, wherein the simulated sensor comprises a sensor configured for use on a satellite.

Any of the features herein, wherein the simulated resource comprises at least one of simulated software, simulated hardware, and a simulated compute node.

Any of the features herein, wherein the cloud environment is executed on a satellite.

Any of the features herein, wherein the cloud environment is executed on a terrestrial server.

Any of the features herein, wherein at least one of the three or more distributed computes are virtualized.

Any of the features herein, wherein all of the three or more distributed computes are virtualized.

Any of the features herein, wherein the three or more distributed computes comprise at least one of a micro controller, a micro-processor, a payload server, and an edge server.

Any of the features herein, wherein communication with the remote resource is facilitated by at least one of a physical input output hardware abstraction layer (IO-HAL) and an application hardware abstraction layer (AH-AL).

Any of the features herein, wherein the IO-HAL comprises an abstracted physical communication interface.

Any of the features herein, wherein the AH-AL comprises an abstracted application layer of a physical communication interface.

Any of the features herein, wherein the communication with the remote resource is facilitated by transmitting one or more JSON files.

Any of the features herein, wherein the one or more JSON files define at least one of a current API execution time, a timing dependent API, a relative execution time, an execution mode, and a number of arguments.

Any of the features herein, wherein the one or more JSON files are converted into one or more API calls.

Any aspect in combination with any one or more other aspects.

Any one or more of the aspects disclosed herein.

Any one or more of the features as substantially disclosed herein.

Any one or more of the features as substantially disclosed herein in combination with any one or more other features as substantially disclosed herein.

Any one of the aspects/features/implementations in combination with any one or more other aspects/features/implementations.

Use of any one or more of the aspects or features as disclosed herein.

It is to be appreciated that any aspect or feature described herein can be claimed in combination with any other aspect(s) or feature(s) as described herein, regardless of whether the features come from the same described implementation.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

### BRIEF DESCRIPTION OF THE DRAWINGS

FIG. 1 shows aspects of a system in accordance with embodiments of the present disclosure;

FIG. 2 shows additional aspects of the system in accordance with embodiments of the present disclosure;

FIG. 3 shows additional aspects of the system in accordance with embodiments of the present disclosure;

FIG. 4 shows aspects of the system in a cloud environment in accordance with embodiments of the present disclosure;

FIG. 5 shows a call flow diagram in accordance with embodiments of the present disclosure;

FIG. 6 shows a remote node connected to a cloud platform in accordance with embodiments of the present disclosure;

FIG. 7 shows another call flow diagram in accordance with embodiments of the present disclosure;

FIG. 8 shows another remote node connected to a cloud platform in accordance with embodiments of the present disclosure;

FIG. 9 shows another call flow diagram in accordance with embodiments of the present disclosure;

FIG. 10 shows another remote node connected to a cloud platform in accordance with embodiments of the present disclosure;

FIG. 11A shows a first portion of a call flow diagram in accordance with embodiments of the present disclosure;

FIG. 11B shows a second portion of the call flow diagram in accordance with embodiments of the present disclosure;

FIG. 12 shows another remote node connected to a cloud platform in accordance with embodiments of the present disclosure;

FIG. 13 shows another call flow diagram in accordance with embodiments of the present disclosure;

FIG. 14 shows another remote node connected to a cloud platform in accordance with embodiments of the present disclosure;

FIG. 15 shows another call flow diagram in accordance with embodiments of the present disclosure;

FIG. 16 shows another remote node connected to a cloud platform in accordance with embodiments of the present disclosure;

FIG. 17 shows another call flow diagram in accordance with embodiments of the present disclosure;

FIG. 18 shows aspects of the system in a cloud environment in accordance with embodiments of the present disclosure;

FIG. 19 shows aspects of a JSON template in accordance with embodiments of the present disclosure;

FIG. 20 shows another call flow diagram in accordance with embodiments of the present disclosure;

FIG. 21A shows aspects of a JSON template in accordance with embodiments of the present disclosure;

FIG. 21B shows additional aspects of the JSON template in accordance with embodiments of the present disclosure;

FIG. 22 shows another call flow diagram in accordance with embodiments of the present disclosure;

FIG. 23 shows additional aspects of a JSON template in accordance with embodiments of the present disclosure;

FIG. 24 shows another call flow diagram in accordance with embodiments of the present disclosure;

FIG. 25 shows a system with a multi-user mode in accordance with embodiments of the present disclosure;

FIG. 26 shows a system with another multi-user mode in accordance with embodiments of the present disclosure; and

FIG. 27 shows a system with another multi-user mode in accordance with embodiments of the present disclosure.

### DETAILED DESCRIPTION

Embodiments of the present disclosure will be described in connection with a virtual FlatSat and distributed digital nodes.

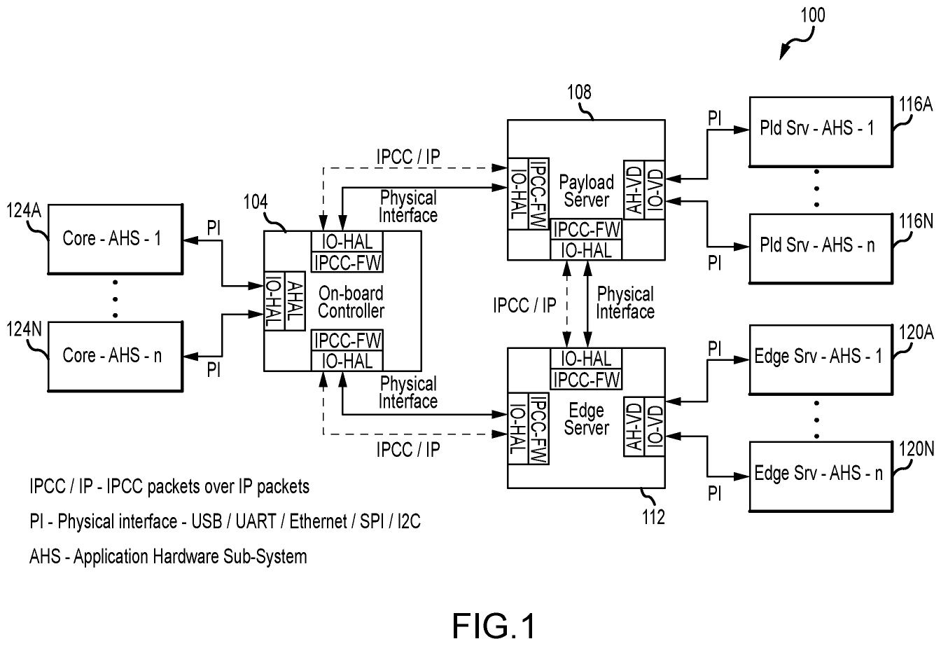

FIG. 1 illustrates aspects of a system 100 in accordance with embodiments of the present disclosure. The system 100 includes an on-board controller 104, a payload server 108, an edge server 112, payload server application hardware sub-systems (AHS) 116A-116N, edge server application hardware sub-systems (AHS) 120A-120N, and core application hardware sub-systems (AHS) 124A-124N. Notwithstanding the foregoing, the system 100 may include additional or alternative components to those illustrated in FIG. 1, and may additionally or alternatively exclude certain components shown in FIG. 1. For example, the system 100 may comprise additional AHS, additional processing circuitry, additional or alternative servers, and/or the like.

The on-board controller 104 may include a micro controller, a micro-processor, a processor, and/or the like that can be connected to the core AHS 124A-124N to regulate or manage the core AHS 124A-124N. The core AHS 124A-124N may be or comprise, for example, an Attitude Determination and Control System (ADCS), Inertial Measurement Units (IMUs), sensors (e.g., temperature sensors, pressure sensors, etc.), and/or the like. The on-board controller 104 may be connected to the core AHS 124A-124N through a Physical Interface (PI). The PI may be or comprise, for example, a Universal Serial Bus (USB), a Universal Asynchronous Receiver-Transmitter (UART), Ethernet, Serial Peripheral Interface (SPI), Inter-Integrated Circuit (I2C), a Peripheral Component Interconnect (PCI), and/or the like.

The payload server 108 comprises processing circuitry capable of supporting multiple missions with resource demands of the payload server AHS 116A-116N. For example, the payload server 108 may perform tasks such as running payload applications for on-orbit operations, data processing, data communication, security, other onboard non-mission critical operations such as offloading one or more tasks from the edge server 112 and/or the on-board controller 104, and/or the like.

The edge server 112 comprises processing circuitry capable of supporting multiple missions with resource demands of the edge server AHS 120A-120N. For instance, the edge server 112 may enable computing through the use of one or more artificial intelligence (AI) and/or machine learning (ML) data models, algorithms, and/or the like. Such AI and/or ML models may enable and/or assist with station keeping, resource optimization, debris avoidance (e.g., when navigating a satellite), decommissioning management, combinations thereof, and/or the like.

The computing nodes such as the on-board controller 104, the payload server 108, and the edge server 112 may be respectively connected to the core AHS 124A-124N, the payload server AHS 116A-116N and the edge server AHS 120A-120N. In some examples, the computing nodes and the AHS are real target hardware platforms that are interconnected to each other with physical IO buses such as through USB, UART, Ethernet, I2C, and/or any other similar communication IO bus. The physical IO bus connections between any of the on-board controller 104, the payload server 108, and the edge server 112 may include low level IO drivers. The low level IO drives may, in some examples, be abstracted using IO Hardware Abstraction Layer (HAL).

In some cases, in addition to the IO abstraction of the low level IO drives, Internet Protocol (IP) based protocols are used over the IO bus interface drivers. For example, Remote Network Driver Interface Specification (RNDIS) drivers or Abstract Control Model (ACM) drivers and/or similar protocols can be used with USB, Point-to-Point Protocol (PPP) drivers and/or similar protocols can be used with UART, and Internet Protocol over Ethernet (IPoE) drivers and/or similar protocols can be used with Ethernet. As a result, interconnection between the three computing hardware/computing nodes (e.g., the on-board controller 104, the payload server 108, the edge server 112) effectively becomes IP-based interconnection. This may enable an International Packet Communications Consortium (IPPC) header and frame formatting and application-level security to be built on top of the IP layer.

In some cases, the IO bus interface connections between the on-board controller 104 and the core AHS 124A-124N may implement an IO bus abstraction framework. The IO abstraction may be implemented because the software running on the on-board controller 104 (as well as other software and applications) accesses the core AHS 124A-124N for the purposes of reading and writing data. By abstracting the IO bus, changes to the core AHS 124A-124N will not affect the application running in the on-board controller 104 and accessing the core AHS 124A-124N.

In some cases, the physical IO bus interface connection between the payload server 108 and the payload server AHS 116A-116N, as well as the physical IO bus interface connection between the edge server 112 and the edge server AHS 120A-120N, may or may not implement an IO bus abstraction framework. For example, IO bus abstraction framework may not be implemented in instances where the IO bus driver and the application that access the hardware to read/write data are offered by a hardware vendor. In this example, the application may be treated like a black box, such that the system 100 does not directly access the hardware sub-system for reading and/or writing data. As a result, the abstraction of the IO bus driver may be unnecessary. In some examples, the AHS is changed and the corresponding driver and application to be run in the payload server 108 will also change. Additionally, the AHS may be provided by the application hardware vendor. As a result, in some cases the system 100 may not implement hardware abstraction between the payload server 108 and the payload server AHS 116A-116N and/or between the edge server 112 and the edge server AHS 120A-120N. Additionally or alternatively, the connectivity between the payload server 108 and the payload server AHS 116A-116N and the connectivity between the edge server 112 and the edge server AHS 120A-120N may not require IP-based interconnections (e.g., the PI interfaces may be sufficient). It is to be understood, however, that various embodiments of the present disclosure may implement IO bus abstractions and/or IP-based interconnections between the payload server 108 and the payload server AHS 116A-116N and/or between the edge server 112 and the edge server AHS 120A-120N.

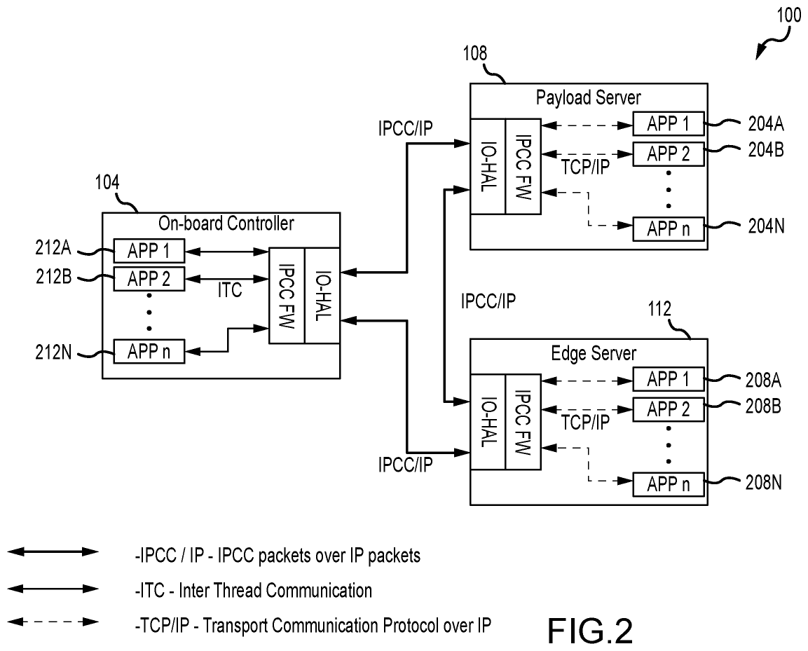

With reference to FIG. 2, the on-board controller 104, the payload server 108, and the edge server 112 may have respective on-board controller applications 212A-212N, payload server applications 204A-204N, and edge server applications 208A-208N. Each of the applications 212A-212N, 204A-204N, 208A-208N may respectively correspond to an AHS connected to the on-board controller 104, the payload server 108, or the edge server 112. In some cases, the applications may run inside the payload server 108 as a virtual machine or the like. Each application may have its own IP address to communicate with other components of the system 100. Similarly, the IPCC framework (IPCCFW) running in the payload server 108 may have its own IP address. As a result, the communication between the IPCCFW in the payload server 108 and the payload server applications 204A-204N may be an IP communication, such as Transmission Control Protocol over Internet Protocol (TCP/IP) or User Diagram Protocol/Internet Protocol (UDP/IP). Within the on-board controller 104, the IPCCFW may communicate with the applications on the on-board controller 104 (e.g., the on-board controller applications 212A-212N) using Inter Task Communication (ITC).

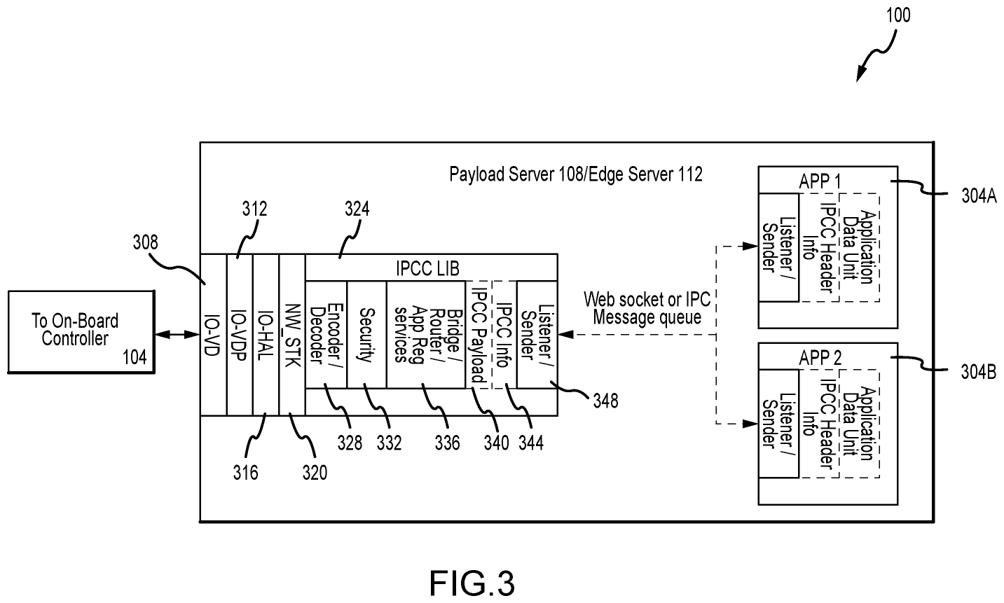

With reference to FIG. 3, the on-board controller 104 may interface and communicate with the payload server 108 and/or the edge server 112. In other words, the following description of the communication flow may occur between the on-board controller 104 and the payload server 108 and/or between the on-board controller 104 and the edge server 112. As depicted in FIG. 3, the payload server 108 and/or the edge server 112 may run one or more applications 304A-304B. The applications 304A-304B may be similar to or the same as the payload server applications 204A-204N and/or to the edge server applications 208A-208N. It should be understood that, while two applications 304A, 304B are illustrated in FIG. 3, the payload server 108 and/or the edge server 112 may run fewer or additional applications.

Each application 304A, 304B may include an application data unit, IPCC header information, and a listener/sender. The listener/sender may enable the applications 304A-304B to interface with the IPCCFW, as illustrated in FIG. 3 with the dotted line. The interface supported between the applications 304A-304B and the IPCCFW may be native Linux IPC (Linux message queue), a web socket (e.g., TCP/IP, UDP/IP, etc.), combinations thereof, and/or the like. In examples where both the message queue and IP based are used, other inter process/task/service communication may be applied. As a result, there may be an initialization process for each application 304A, 304B to register the application 304A, 304B for dynamic interface selection. Additionally or alternatively, the type of interface between each of the applications 304A-304B and the IPCCFW may be selected during build based on user input when there is static interface selection (e.g., the user chooses either a message queue or an IP-based interface between the application and the IPCCFW).

The IPCCFW of the payload server 108 and/or the edge server 112 comprises a plurality of layers. The IPCC comprises an input output vendor driver (IO-VD) 308, an input output vendor driver porting layer (IO-VDP) 312, an input output hardware abstraction layer (IO-HAL) 316, a network stack 320, and an IPCC library 324. The IO-VD 308 may operate as a physical IO bus interface to enable communication between the on-board controller 104 and the payload server 108 and/or the edge server 112. The IO-VDP 312 may include a wrapper layer and an abstraction layer. On top of the IO-VDP 312, the network stack 320 may be added. The network stack 320 may be RNDIS in the case of a USB interface, PPP in the case of an UART interface, and Point-to-Point Protocol over Ethernet (PPPoE) in the case of an Ethernet interface. The IPCC library 324 may be positioned on top of the network stack 320 in the stack.

The IPCC library 324 may contain various sub-modules, such as an encoder/decoder 328, security 332, a bridge/router/application registration service 336, an IPCC payload 340, IPCC information 344, and a listener/sender 348. The encoder/decoder 328 may encode and/or decode messages or other information communicated between the payload server 108 and/or the edge server 112 and the on-board controller 104. The security 332 may perform authentication of messages or other information communicated with the IPCCFW, and may additionally or alternatively perform ciphering and de-ciphering. The bridge 336 may perform routing and/or packet forwarding of messages or other information communicated via the IPCCFW. In some cases, the bridge 336 may perform application registration services, such as when one or more of the applications 304A-304B are initialized and run on the payload server 108 and/or the edge server 112. The IPCC payload 340 may comprise information being communicated via the IPCCFW. The IPCC information 344 may comprise information pertaining to IPCC or, more generally, to the IPCCFW. For example, the IPCC information 344 may comprise information about the bandwidth capabilities of the IPCCFW.

The listener/sender 348 may be web socket-based (e.g., TCP/IP, UDP/IP) or native Linux IPC message queue. The listener/sender 348 may be similar to or the same as the listener/sender present in one or more of the applications 304A-304B, such that the applications 304A-304B can communicate with the IPCC library 324 (and vice versa). In some cases, the listener/sender 348 and the listener/sender of the applications 304A-304B may be used to establish, maintain, and/or terminate communication between the IPCC library 324 and the applications 304A-304B.

In instances where the applications 304A-304B are written as virtual machines or otherwise containerized, the communication between the applications 304A-304B and the IPCC library 324 may benefit from IP-based communications. In other cases where the applications 304A-304B are written as native libraries that support standard IPC communications (e.g., message queues), the communication between the applications 304A-304B and the IPCC library 324 may benefit from non IP-based communications. As a result, both Linux IPC messaging and IP-based interfaces may be provided.

When the applications 304A-304B communicate via IPCC, the applications 304A-304B may undergo service registration, and the IPCCFW assigns each application 304A, 304B an application ID. This may occur at the time of Power-on Initialization (PoI) or whenever the application begins initiation. In some cases, the registration may occur through a pre-configuration provided at the build time of the application. The IPCCFW will then provide one or more Application Programming Interfaces (APIs) for registration and de-registration. The APIs may be or comprise interfaces rendered on a display for a user to view and/or with which the user may interact. The application may use the APIs for registering and de-registering, and in some cases an initial registration of the application may be required to access the computing nodes (e.g., the payload server 108, the edge server 112, etc.). The application ID may be used for the purposes of communication between the registered application and other applications, as well as for IPCC session maintenance for the application. In some examples, the application ID may be used by the IPCCFW for further IPCC message mapping/forwarding, as well as to restrict application access for security purposes.

When any of the applications 304A-304B wish to send application data unit(s) (ADUs) to the on-board controller 104, the application may provide IPCC header information along with the ADU. The IPCC header information may include a variety of parameters. In one example, the IPCC header includes a source hardware device ID (e.g., originating from the on-board controller 104, the payload server 108, or the edge server 112), a source application or session ID, a destination hardware device ID (e.g., intended for the on-board controller 104, the payload server 108, or the edge server 112), a destination application or session ID, a packet sequence number, an IPCCFW level encryption or decryption (which may be or comprise a binary indicator of whether encryption/decryption is desired at the IPCCFW level), and/or an IPCCFW level message authentication (which may be or comprise a binary indicator of whether message authentication is desired at the IPCCFW level). Such parameters may have different data sizes (e.g., 1 bit, 1 byte, 2 bytes, etc.). It is to be understood that the above parameter information may be the base fields for the IPCCFW, and that additional or alternative IPCC information may be added to support various scenarios and applications.

Once the IPCCFW receives the IPCC header information and the ADU from the application, the IPCC header information may be used to perform several functions. For example, the security 332 of the IPCCFW may use the header information to enable encryption and/or authentication. As another example, the bridge 336 may perform registration services, such as generating an application ID, perform maintenance on sequence number, combinations thereof, and/or the like. As yet another example, the IPCC library 324 may perform encoding/decoding of the IPCC header (e.g., using the encoder/decoder 328). The encoder/decoder 328 may treat the data unit as a raw byte stream, generate IPCC data packet(s), and send the IPCC data packet(s) across to the destination hardware device (e.g., if the IPCC designated the on-board controller 104 as the destination hardware device, the IPCCFW sends the packet to the on-board controller 104). The IPCCFW may also remove the IPCC header information and map/forward the ADU to the respective application. The mapping and forwarding may be performed by the bridge 336. For example, when one or more of the applications 304A-304B running on the payload server 108 wants to send a message and/or data to the on-board controller 104, the applications 304A-304B may provide the ADU to communicate with the on-board controller 104 and may send the IPCC header along with the ADU. In some cases, the IPCC header information can be another raw byte system, but follows the byte order specified by the IPCCFW. The byte system may enable any one or more of the applications 304A-304B to be containerized such that, for example, the applications 304A-304B do not need to depend on any particular programming language. Additionally or alternatively, such a configuration may enable the applications 304A-304B to be agnostic to the IPCC packet format, IPCC message/header encoding/decoding, combinations thereof, and/or the like. As previously mentioned, while the discussion of applications 304A-304B is made with respect to the payload server 108, the same features may be applied to the applications 304A-304B run on the edge server 112, as well as with respect to any computing node or computer that uses IPCC interfaces for communication across processing nodes.

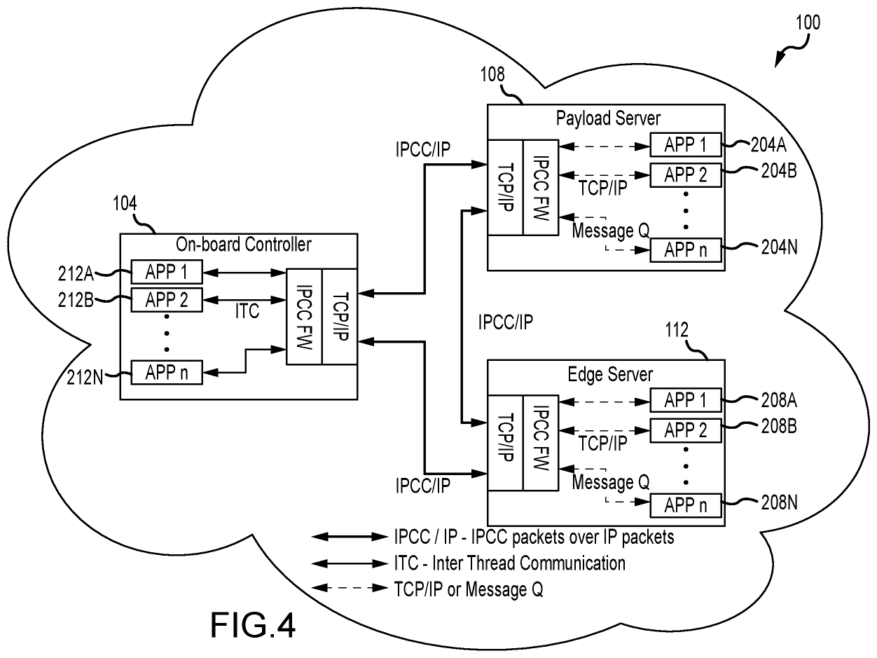

With reference to FIG. 4, the computing nodes, including the on-board controller 104, the payload server 108, and the edge server 112 are soft simulated in a cloud platform in accordance with embodiments of the present disclosure. In the cloud platform, the payload server AHS 116A-116N, the core AHS 124A-124N, and/or the edge server AHS 120A-120N may be running in remote nodes at the client end, with the remote nodes connected to the cloud platform via, for example, IP connectivity. As depicted in FIG. 4, the main computing nodes (e.g., the on-board controller 104, the payload server 108, and the edge server 112) may communicate via IPCC packets over IP packets.

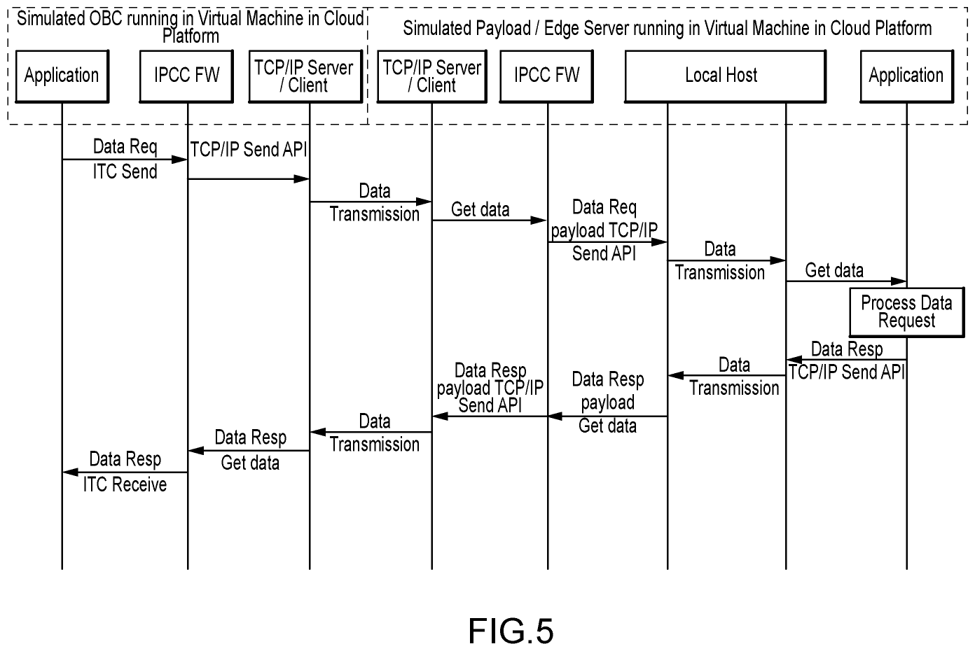

With reference to FIG. 5, a call flow diagram depicting the interaction of the on-board controller 104, the payload server 108, and the edge server 112 in the cloud platform is illustrated according to embodiments of the present disclosure. The application running in the on-board controller 104 (e.g., any application of the on-board controller applications 212A-212N) sends a data request via ITC to the IPCCFW of the on-board controller 104. The IPCCFW then sends an API over the TCP/IP to the TCP/IP server or client (e.g., IO-VD 308), which transmits the data to the TCP/IP server or client in the payload server 108 or the edge server 112. The TCP/IP server then requests data from the IPCCFW in the payload server 108 or the edge server 112. The IPCCFW then sends a data request payload to the TCP/IP, and the API is sent to the local host. The local host may then access local applications to process the data request. After the data request is processed by the application, the application may send an API to the local host, which transmits the data to the IPCCFW. After, the IPCCFW sends a payload containing the response to the TCP/IP server or client. The TCP/IP server may then transfer the data to the on-board controller 104, which then routes the data transmission to the application via the IPCCFW.

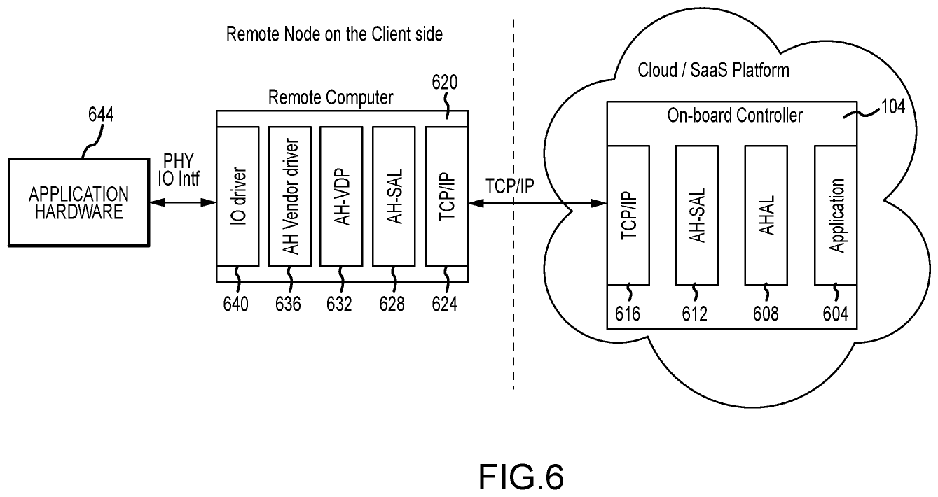

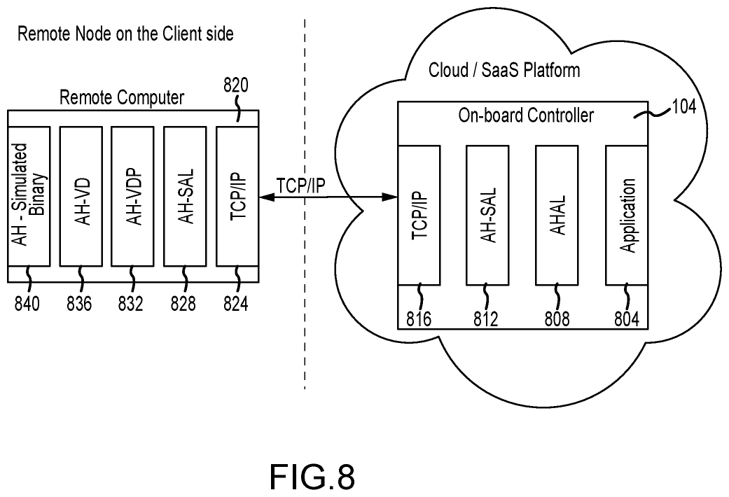

In some cases, one or more application hardware sub-systems (e.g., the payload server AHS 116A-116N, the core AHS 124A-124N, and/or the edge server AHS 120A-120N) can be connected to the main software simulated computing nodes. The connection may be simulated (e.g., a simulated sensor such as a temperature sensor, an IMU, etc.) in a remote computer, with the remote computer connected to the main software simulated computing nodes (e.g., on-board controller 104, payload server 108, or edge server 112) through a TCP/IP socket connection, as illustrated in FIG. 8. Alternatively, the application hardware subsystem(s) may be real physical hardware (e.g., temperature sensor hardware) that is connected to a remote computer through a physical IO bus interface (e.g., UART, I2C), as depicted in FIG. 6. As a result, the cloud platform of the system 100 provides a SaaS platform or environment for a vendor/client to integrate and/or test developed application hardware sub-system(s) with a simulated software in a SaaS platform so that the application hardware is integrated and qualified. In some embodiments, the simulated software may be a satellite platform, while in other embodiments the simulated software may be a terrestrial platform.

With reference to FIG. 6, a remote node connected to a cloud platform is shown in accordance with embodiments of the present disclosure. The cloud platform includes the on-board controller 104, which has an application 604 (which may be similar to or the same as any of the on-board controller applications 212A-212N), an application hardware abstraction layer (AHAL) 608, an application hardware simulation adaption layer (AH-SAL) 612, and a TCP/IP port 616. The remote node includes a remote computer 620 that has a TCP/IP port 624, an AH-SAL 628, an application hardware vendor porting layer (AH-VDP) 632, an AH vendor driver (AH-VD) 636, and an IO vendor driver (IO-VD) 640 that is in communication with application hardware 644 via a physical IO interface. In some cases, the application hardware sub-systems may be or comprise real physical hardware that is connected to the remote computer 620. The connection may be a physical interface (e.g., UART, I2C). The driver of the application hardware sub-system (e.g., a temperature sensor driver) may run in the remote computer (e.g., a home computer). The remote computer can then be connected to the main soft simulated computing nodes (e.g., the on-board controller 104, the payload server 108, or the edge server 112) through the TCP/IP socket communication (e.g., between TCP/IP 616 and TCP/IP 624).

The input or output data from the application hardware 644 is accessed or retrieved by the AH-VD 636, which invokes the AH-VDP 632. The AH-VDP 632 then invokes an AHAL API which in turn invokes the AH-SAL 628. The AH-SAL 628, after conversion, invokes a socket interface such as a TCP/IP interface 624. As a result, data from the application hardware 644 is transmitted via a socket interface to the soft simulated on-board controller 104 running in a virtual machine in a cloud platform.

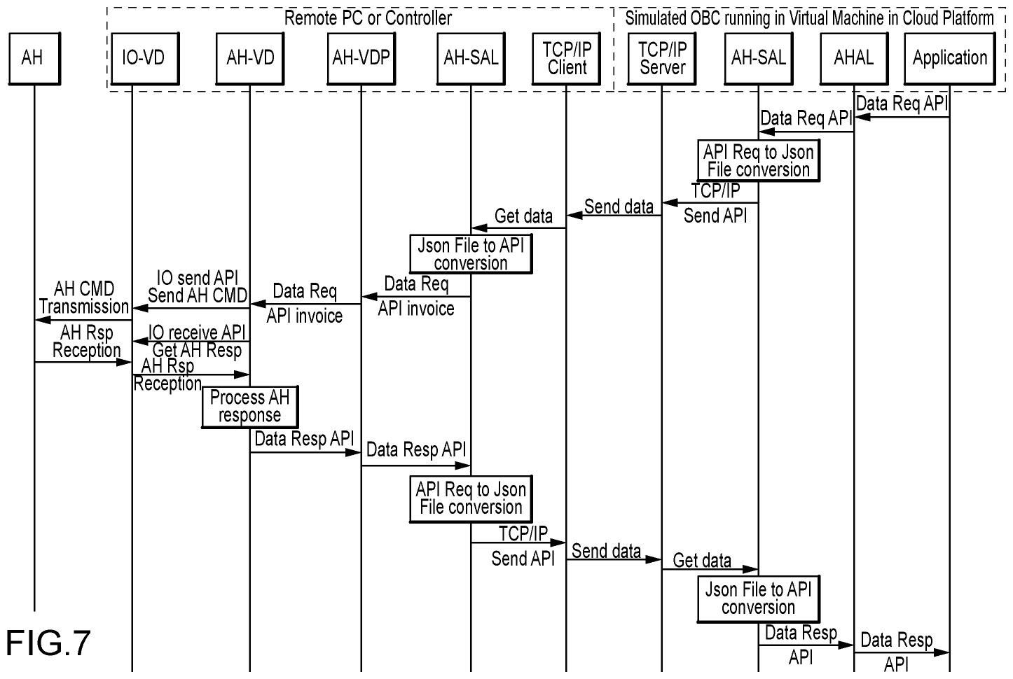

With reference to FIG. 7, a call flow diagram for a remotely connected application hardware is shown in accordance with embodiments of the present disclosure. In some cases, the call flow diagram of FIG. 7 may be a call flow for the interaction depicted in FIG. 6. An application 604 running on the virtual machine in the cloud platform (e.g., an application running on the simulated on-board controller 104) may send a data request API to the AHAL 608, which forwards the data request API to the AH-SAL 612. The AH-SAL 612 then converts the API request to a JSON file, and sends the file to the remote computer or controller via the TCP/IP interface (e.g., from the TCP/IP 616 to the TCP/IP 624). The TCP/IP 624 then pushes the data to the AH-SAL 628, which performs a JSON file to API conversion, and sends the API data request to the AH-VDP 632. The AH-VDP 632 then forwards the request to the AH-VD 636, which in turn sends the API and a command to the IO-VD 640. The command may instruct the application hardware 644 to perform a specific function (e.g., generate temperature data when the application hardware 644 includes a temperature sensor). The IO-VD 640 may also send at a later time an instruction to cause the application hardware 644 to send a response, such as to send data generated by the application hardware 644 after the application hardware 644 has performed the specific function. The application hardware 644 then sends the response via the IO-VD 640 to the AH-VD 636. The AH-VD 636 then processes the response from the application hardware 644, and sends the data response API through the AH-VDP 632 and the AH-SAL 628. The AH-SAL 628 then converts the API to a JSON file, and sends the data through the TCP/IP 624 to the TCP/IP 616. The TCP/IP 616 sends the data to the AH-SAL 612, which converts the JSON file to an API. The response API is then sent back to the AHAL 608 and finally back to the application 604 running on the on-board controller 104. It is to be understood that, while the API is described as being converted into a JSON file, the API may be converted into other file types, such as a text file, a Protocol Buffer, a csv file, and/or the like.

Turning to FIG. 8, a remote node connected to a cloud platform is shown in accordance with embodiments of the present disclosure. The cloud platform includes the on-board controller 104, which has an application 804, an AHAL 808, an AH-SAL 812, and a TCP/IP port 816. The remote node includes a remote computer 820 that has a TCP/IP port 824, an AH-SAL 828, an AH-VDP 832, an AH-VD 836, and application hardware 840. In some cases, the application 804, the AHAL 808, the AH-SAL 812, the TCP/IP port 816, the remote computer 820, the TCP/IP port 824, the AH-SAL 828, the AH-VDP 832, and the AH-VD 836 may be respectively similar to or the same as the application 604, the AHAL 608, the AH-SAL 612, the TCP/IP port 616, the remote computer 620, the TCP/IP port 624, the AH-SAL 628, the AH-VDP 632, and the AH-VD 636.

In some cases such as those depicted in FIG. 8, the simulation application hardware sub-system (e.g., a soft simulated temperature sensor) can be running in the remote home computer and the remote home computer can be connected to the soft simulated on-board controller 104 through a TCP/IP socket communication. In these cases, the input and output data from the application hardware 840 is accessed or retrieved by the AH-VD 836, which invokes the AH-VDP 832. The AH-VDP 832 then invokes an AHAL API which in turn invokes the AH-SAL 828. The AH-SAL 828, after conversion, invokes a socket interface such as a TCP/IP interface 824. As a result, data from the application hardware 840 is transmitted via a socket interface to the soft simulated on-board controller 104 running in a virtual machine in a cloud platform. This call flow may enable testing of the vendor driver and the vendor driver porting layer (e.g., the AH-VD 836).

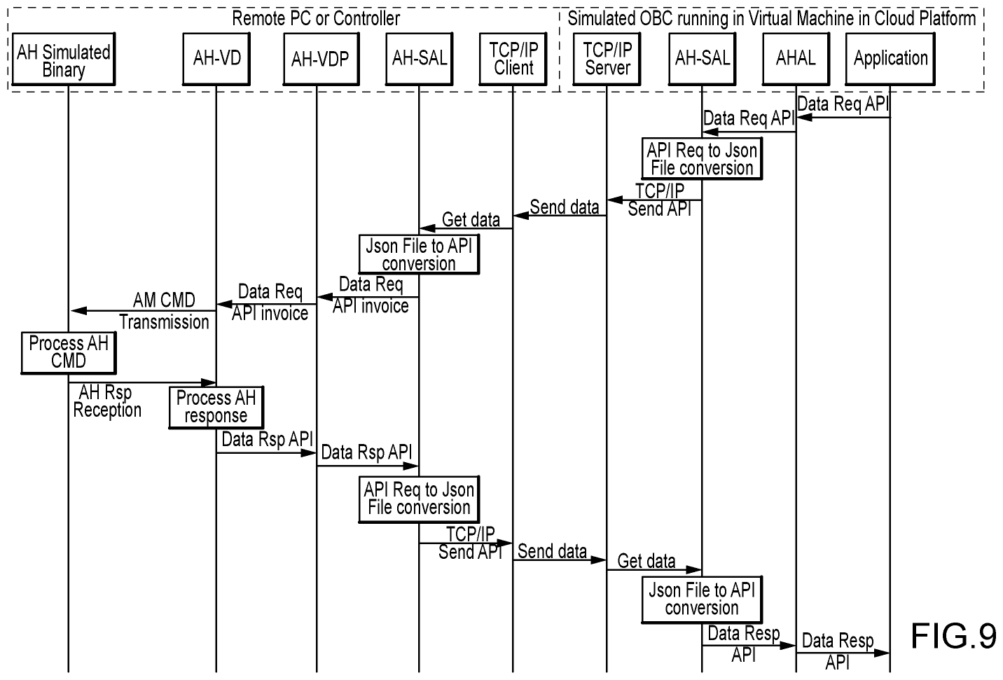

With reference to FIG. 9, a call flow diagram for simulated application hardware running in a remote computer is shown in accordance with embodiments of the present disclosure. An application 804 running on the virtual machine in the cloud platform (e.g., an application running on the simulated on-board controller 104) may send a data request API to the AHAL 808, which forwards the data request API to the AH-SAL 812. The AH-SAL 812 then converts the API request to a JSON file, and sends the file to the remote computer or controller via the TCP/IP interface (e.g., from the TCP/IP 816 to the TCP/IP 824). The TCP/IP 824 then pushes the data to the AH-SAL 828, which performs a JSON file to API conversion, and sends the API data request to the AH-VDP 832. The AH-VDP 832 then forwards the request to the AH-VD 836, which in turn sends a command to the application hardware 840. The command may instruct the application hardware 840 to perform a specific function (e.g., generate temperature data when the application hardware 840 includes a temperature sensor). The application hardware 840 then processes the command and generates a response that is received by the AH-VD 836. The AH-VD 836 then processes the response from the application hardware 840, and sends the data response API through the AH-VDP 832 and the AH-SAL 828. The AH-SAL 828 then converts the API to a JSON file, and sends the data through the TCP/IP 824 to the TCP/IP 816. The TCP/IP 816 sends the data to the AH-SAL 812, which converts the JSON file to an API. The response API is then sent back to the AHAL 808 and finally back to the application 804 running on the on-board controller 104. It is to be understood that, while the API is described as being converted into a JSON file, the API may be converted into other file types, such as a text file, a Protocol Buffer, a csv file, and/or the like.

The AH-SAL discussed herein (e.g., the AH-SAL 612, the AH-SAL 628, the AH-SAL 812, the AH-SAL 828, etc.) converts the API into a JSON file format (or, more generally, another file format). The conversion may include converting the API name to an API ID with comma separation, and converting API arguments into comma separated arguments with a name followed by a value. The JSON file may then be transmitted via the TCP/IP socket. Similarly, the AH-SAL may parse a received JSON file formatted byte stream and extract the API ID, the number of arguments, the argument values, and/or the like. The AH-SAL may then invoke the respective AHAL API with the extracted parameters. For pointer type arguments, the AH-SAL may allocate memory accordingly, update the data into the allocated memory, and update the address in the pointer variable.

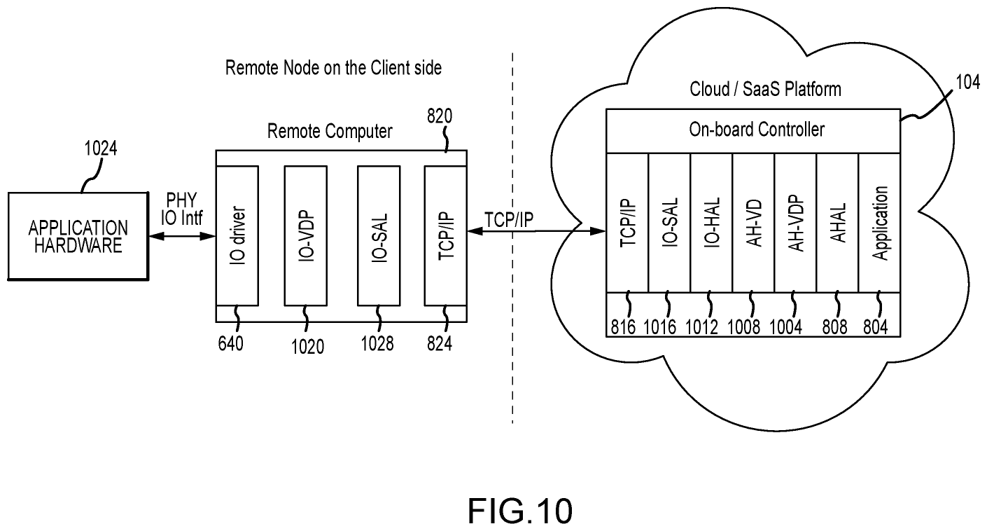

Turning next to FIG. 10, a remote node connected to a cloud platform is shown in accordance with embodiments of the present disclosure. The cloud platform includes the on-board controller 104, which has the application 804, the AHAL 808, an AH-VDP 1004, an AH-VD 1008, an IO-HAL 1012, an IO-SAL 1016, and the TCP/IP port 816. The remote node includes the remote computer 820 that has the TCP/IP port 824, an IO-SAL 1028, an IO-VDP 1020, and the IO-VD 640 connected to application hardware 1024 via a physical IO interface.

In some cases, the configuration shown in FIG. 10 can be used when the application hardware vendor has already been tested and integrated such that the application hardware vendor is available on the on-board controller 104 running in the cloud platform. The physical application hardware sub-system can be connected to the remote computer 820 (e.g., a home computer) for testing purposes. Within the remote computer 820, data from the application hardware 1024 can be fetched by the IO-SAL 1028. The IO-SAL 1028 then, after conversion, invokes the TCP/IP 824 to send the data to the on-board controller 104 in the cloud platform.

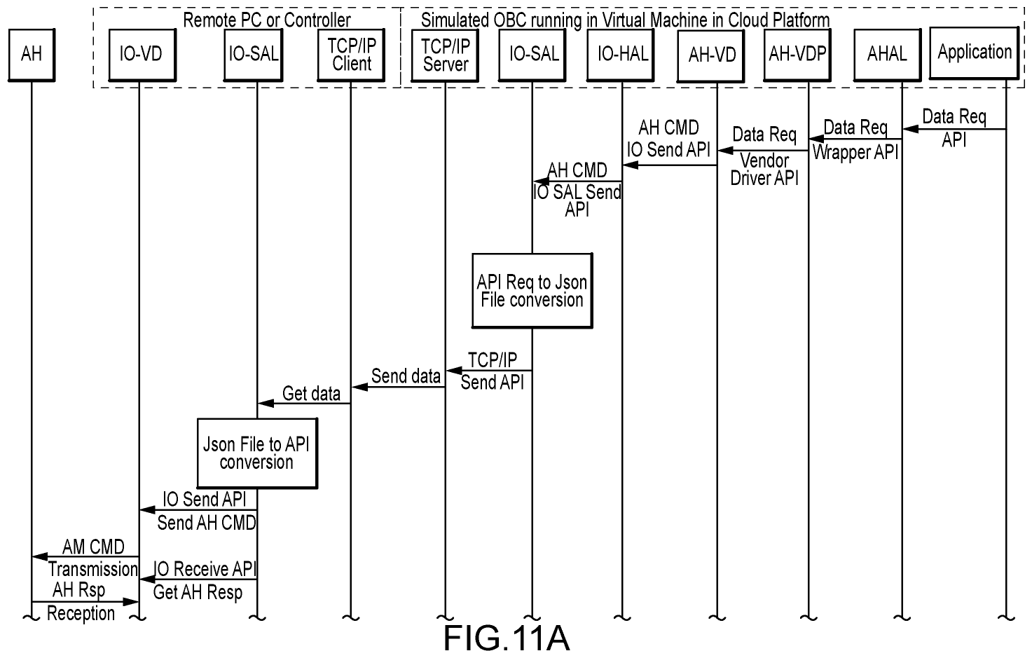

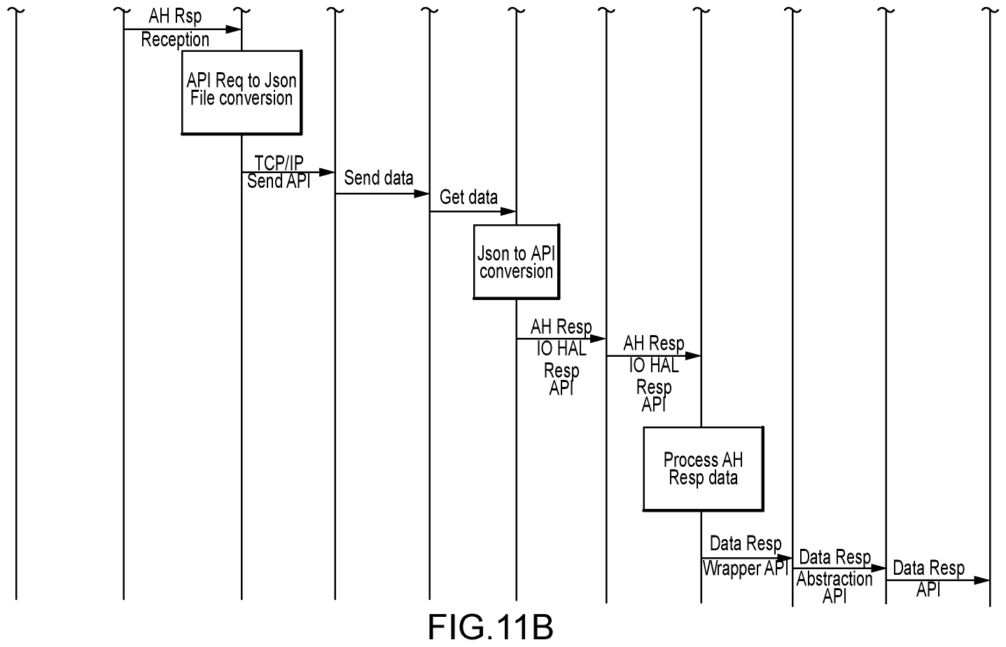

With reference to FIGS. 11A-11B, a call flow diagram for simulated application hardware accessible via a remote computer remotely connected to the on-board controller 104 is shown in accordance with embodiments of the present disclosure. In some cases, the call flow diagram in FIGS. 11A-11B depicts the call flow for the interaction depicted in FIG. 10. An application 804 running on the virtual machine in the cloud platform (e.g., an application running on the simulated on-board controller 104) may send a data request API to the AHAL 808, which forwards the data request API to the AH-VDP 1004. The AH-VDP 1004 then converts the API request into a vendor driver API that is sent to the AH-VD 1008. The AH-VD 1008 then generates one or more commands for the application hardware 1024, and sends the command as an API to the IO-HAL 1012. The IO-HAL 1012 then sends the API to the IO-SAL 1016. The IO-SAL 1016 converts the API request to a JSON file, and sends the file to the remote computer or controller via the TCP/IP interface (e.g., from the TCP/IP 816 to the TCP/IP 824). The TCP/IP 824 then pushes the data to the IO-SAL 1028, which performs a JSON file to API conversion, and sends the API data request to the IO-VD 640. The command may instruct the application hardware 1024 to perform a specific function (e.g., generate temperature data when the application hardware 1024 includes a temperature sensor). The IO-VD 640 may also send at a later time an instruction to cause the application hardware 1024 to send a response, such as to send data generated by the application hardware 1024 after the application hardware 1024 has performed the specific function. The application hardware 1024 then processes the command and generates a response that is received by the IO-VD 640 and forwarded to the IO-SAL 1028. The IO-SAL 1028 then converts the API to a JSON file, and sends the data through the TCP/IP 824 to the TCP/IP 816. The TCP/IP 816 sends the data to the IO-SAL 1016, which converts the JSON file to an API. The response API is then sent back to AH-VDP 1004 through the IO-HAL 1012 and the AH-VD 1008. The AH-VDP 1004 then processes the response data from the application hardware 1024, and provides the response to the application 804 running on the on-board controller 104 through the AHAL 808. It is to be understood that, while the API is described as being converted into a JSON file, the API may be converted into other file types, such as a text file, a Protocol Buffer, a csv file, and/or the like.

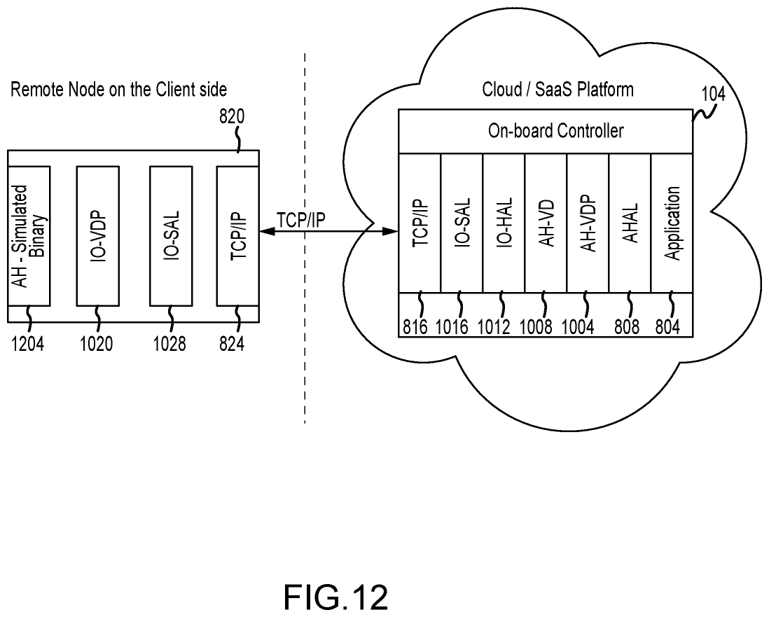

With reference to FIG. 12, a remote node connected to a cloud platform is shown in accordance with embodiments of the present disclosure. The cloud platform includes the on-board controller 104, which has the application 804, the AHAL 808, the AH-VDP 1004, the AH-VD 1008, the IO-HAL 1012, the IO-SAL 1016, and the TCP/IP port 816. The remote node includes the remote computer 820 that has the TCP/IP port 824, an IO-SAL 1028, an IO-VDP 1020, and application hardware 1204.

In some cases, the configuration shown in FIG. 12 can be used when the application hardware vendor has already been tested and integrated such that the application hardware vendor is available on the on-board controller 104 running in the cloud platform. The physical application hardware sub-system may be executed in a remote computer and the data from the simulated application hardware is sent to the on-board controller 104 in the cloud platform using the TCP/IP 824. In this way, the application developed for the on-board controller 104 can be tested in a simulated environment.

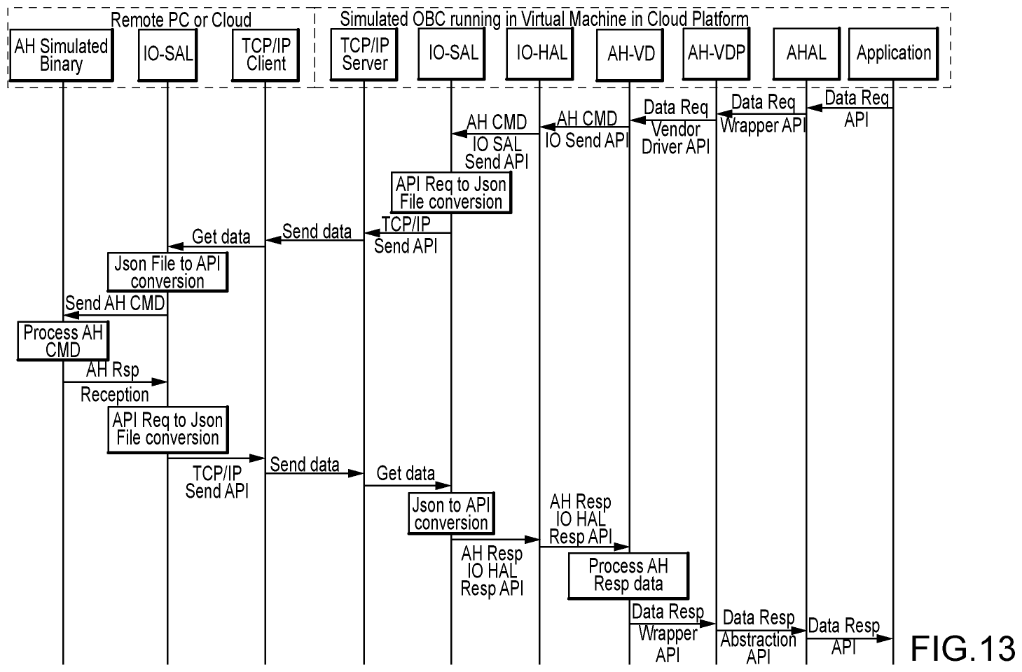

With reference to FIG. 13, a call flow diagram is shown in accordance with embodiments of the present disclosure. In some cases, the call flow diagram in FIG. 13 depicts the call flow for the interaction depicted in FIG. 12. An application 804 running on the virtual machine in the cloud platform (e.g., an application running on the simulated on-board controller 104) may send a data request API to the AHAL 808, which forwards the data request API to the AH-VDP 1004. The AH-VDP 1004 then converts the API request into a vendor driver API that is sent to the AH-VD 1008. The AH-VD 1008 then generates one or more commands for the application hardware 1204, and sends the command as an API to the IO-HAL 1012. The IO-HAL 1012 then sends the API to the IO-SAL 1016. The IO-SAL 1016 converts the API request to a JSON file, and sends the file to the remote computer or controller via the TCP/IP interface (e.g., from the TCP/IP 816 to the TCP/IP 824). The TCP/IP 824 then pushes the data to the IO-SAL 1028, which performs a JSON file to API conversion, and sends a command to the application hardware 1204. The command may instruct the application hardware 1204 to perform a specific function (e.g., generate temperature data when the application hardware 1204 includes a temperature sensor). The application hardware 1204 then processes the command and generates a response that is received by the IO-SAL 1028. The IO-SAL 1028 then converts the API to a JSON file, and sends the data through the TCP/IP 824 to the TCP/IP 816. The TCP/IP 816 sends the data to the IO-SAL 1016, which converts the JSON file to an API. The response API is then sent back to AH-VDP 1004 through the IO-HAL 1012 and the AH-VD 1008. The AH-VDP 1004 then processes the response data from the application hardware 1024, and provides the response to the application 804 running on the on-board controller 104 through the AHAL 808. It is to be understood that, while the API is described as being converted into a JSON file, the API may be converted into other file types, such as a text file, a Protocol Buffer, a csv file, and/or the like.

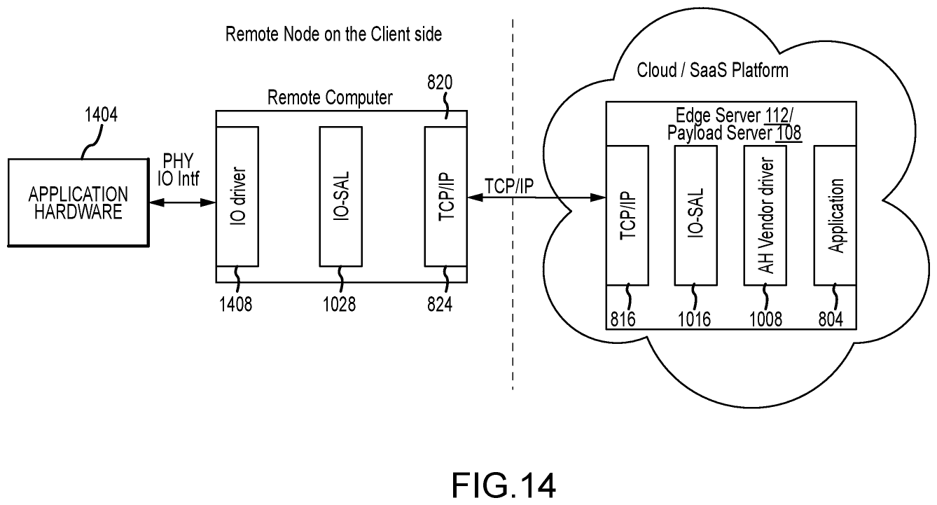

With reference to FIG. 14, a remote node connected to a cloud platform is shown in accordance with embodiments of the present disclosure. The cloud platform includes the payload server 108 and/or the edge server 112, each of which may include the application 804, the AH-VD 1008, the IO-SAL 1016, and the TCP/IP port 816. The remote node includes the remote computer 820 that has the TCP/IP port 824, an IO-SAL 1028, and an IO driver 1408 that is connected to application hardware 1404 through a physical IO interface.

In some cases, the configuration shown in FIG. 14 can be used when the application hardware vendor is available in a simulated payload server 108 or edge server 112 running in the cloud platform. The physical application hardware sub-system may be connected to the remote computer 820 through the physical IO interface. The data from the application hardware 1404 can be fetched by the remote computer 820 (via the IO driver 1408) and sent to the simulated payload server 108/edge server 112 running in the cloud platform using the TCP/IP socket interface.

Within the remote computer 820, data from the application hardware 1404 can be fetched by the IO-SAL 1028. The IO-SAL 1028 then, after conversion, invokes the TCP/IP 824 to send the data to the payload server 108 and/or the edge server 112 in the cloud platform.

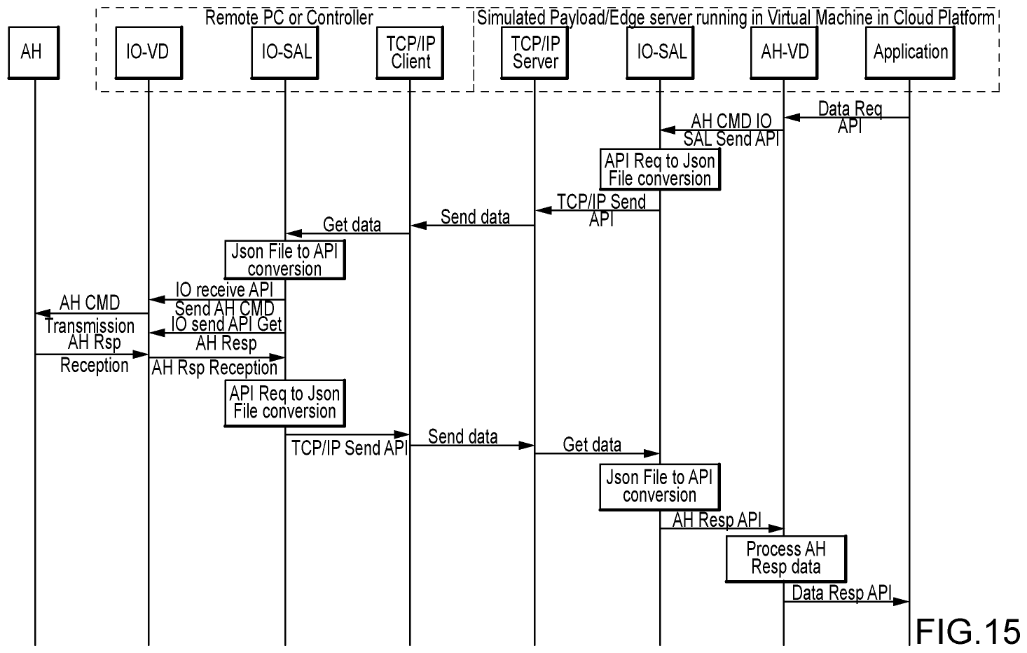

With reference to FIG. 15, a call flow diagram is shown in accordance with embodiments of the present disclosure. In some cases, the call flow diagram in FIG. 15 depicts the call flow for the interaction depicted in FIG. 14. An application 804 running on the virtual machine in the cloud platform (e.g., an application running on the simulated payload server 108 or edge server 112) may send a data request API to the AH-VD 1008, which forwards the data request API to the IO-SAL 1016. The IO-SAL 1016 then converts the API request to a JSON file, and sends the file to the remote computer or controller via the TCP/IP interface (e.g., from the TCP/IP 816 to the TCP/IP 824). The TCP/IP 824 then pushes the data to the IO-SAL 1028, which performs a JSON file to API conversion, and sends the API data request to the IO driver 1408. The IO driver 1408 then sends a command to the application hardware 1404. The command may instruct the application hardware 1404 to perform a specific function (e.g., generate temperature data when the application hardware 1404 includes a temperature sensor). The transmission from the IO-SAL 1028 to the IO driver 1408 may also include a command to receive a response from the application hardware 1404. The application hardware 1404 then sends the response to the IO driver 1408. The IO driver 1408 may forward the response to the IO-SAL 1028, which then converts the API to a JSON file, and sends the data through the TCP/IP 824 to the TCP/IP 816. The TCP/P 816 sends the data to the IO-SAL 1016, which converts the JSON file to an API. The response API is then sent back to the AH-VD 1008, which processes the response data from the application hardware 1404. The processed data is then passed back to the application 604 running on the payload server 108 or the edge server 112. It is to be understood that, while the API is described as being converted into a JSON file, the API may be converted into other file types, such as a text file, a Protocol Buffer, a csv file, and/or the like.

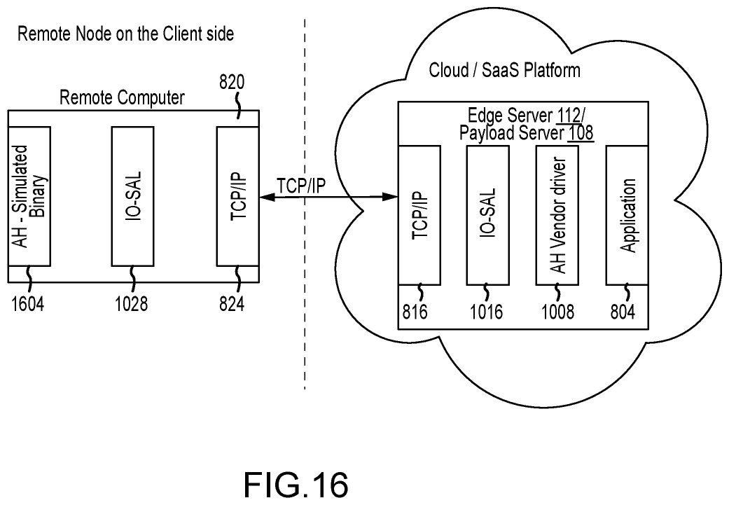

Turning to FIG. 16, a remote node connected to a cloud platform is shown in accordance with embodiments of the present disclosure. The cloud platform includes the payload server 108 and/or the edge server 112, each of which may include the application 804, the AH-VD 1008, the IO-SAL 1016, and the TCP/IP port 816. The remote node includes the remote computer 820 that has the TCP/IP port 824, an IO-SAL 1028, and application hardware 1604.

In some cases, the configuration shown in FIG. 16 can be used when the application hardware vendor is available in a simulated payload server 108 or edge server 112 running in the cloud platform. The physical application hardware sub-system may be run on the remote computer 820. The data from the application hardware 1604 can be sent to the simulated payload server 108/edge server 112 running in the cloud platform using the TCP/IP socket interface. In this way, the application developed for the payload server 108 and/or the edge server 112 can be tested in a simulation environment.

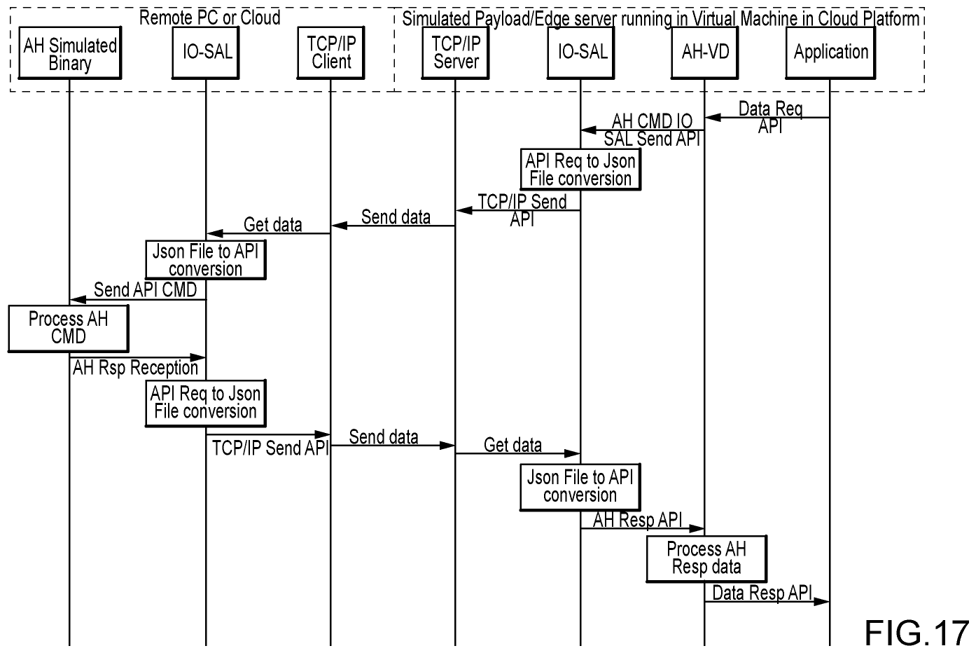

With reference to FIG. 17, a call flow diagram is shown in accordance with embodiments of the present disclosure. In some cases, the call flow diagram in FIG. 17 depicts the call flow for the interaction depicted in FIG. 16. An application 804 running on the virtual machine in the cloud platform (e.g., an application running on the simulated payload server 108 or the edge server 112) may send a data request API to the AH-VD 1008, which forwards the data request API to the IO-SAL 1016. The IO-SAL 1016 then converts the API request to a JSON file, and sends the file to the remote computer or controller via the TCP/IP interface (e.g., from the TCP/IP 816 to the TCP/IP 824). The TCP/IP 824 then pushes the data to the IO-SAL 1028, which performs a JSON file to API conversion, and sends one or more commands to the application hardware 1604. The command may instruct the application hardware 1604 to perform a specific function (e.g., generate temperature data when the application hardware 1604 includes a temperature sensor). The application hardware 1604 then processes the command and generates a response that is received by the IO-SAL 1028. The IO-SAL 1028 then converts the API to a JSON file, and sends the data through the TCP/IP 824 to the TCP/IP 816. The TCP/IP 816 sends the data to the IO-SAL 1016, which converts the JSON file to an API. The response API is then sent back to the AH-VD 1008, which processes the response data from the application hardware 1604. The processed data is then passed into the application 804 running on the payload server 108 or the edge server 112. It is to be understood that, while the API is described as being converted into a JSON file, the API may be converted into other file types, such as a text file, a Protocol Buffer, a csv file, and/or the like.

In some cases, the entire simulation is run as a single instance in the simulation environment, such that one application hardware sub-system (e.g., a temperature sensor) can be tested with the simulation environment. As a result, to test another application hardware sub-system (e.g., an IMU) with the simulation environment, a different instance of the entire simulation may be run. In other cases, there may be a single instance where some or all components will be simulated. In these cases, two, three, or more application hardware sub-systems (e.g., a temperature sensor and an IMU) can be connected in parallel to the same instance of simulation for testing. In some cases, there may be a single generic instance of flight software simulation, and any application hardware sub-system can be tested with the simulation environment. In these instances, the number of application hardware sub-systems may be restricted (e.g., a maximum of six temperature sensors, a maximum of two IMUS, a maximum of two reaction-wheels, etc.).

The IO-SAL (e.g., the IO-SAL 1016, the IO-SAL 1028) may convert API calls to a JSON file formatted byte stream such that the API name is converted to an API ID with comma separation, API arguments are converted to comma separated number of arguments, followed by the arguments. The JSON file is then transmitted via the TCP/IP socket. At the receiving end, the IO-SAL parses the JSON file formatted byte stream and extracts the API ID and the arguments, and then invokes the respective IO-HAL API with the appropriate parameters. For pointer type arguments, the IO-SAL may allocate memory accordingly, update the data into the allocated memory, and update the address in the pointer variable.

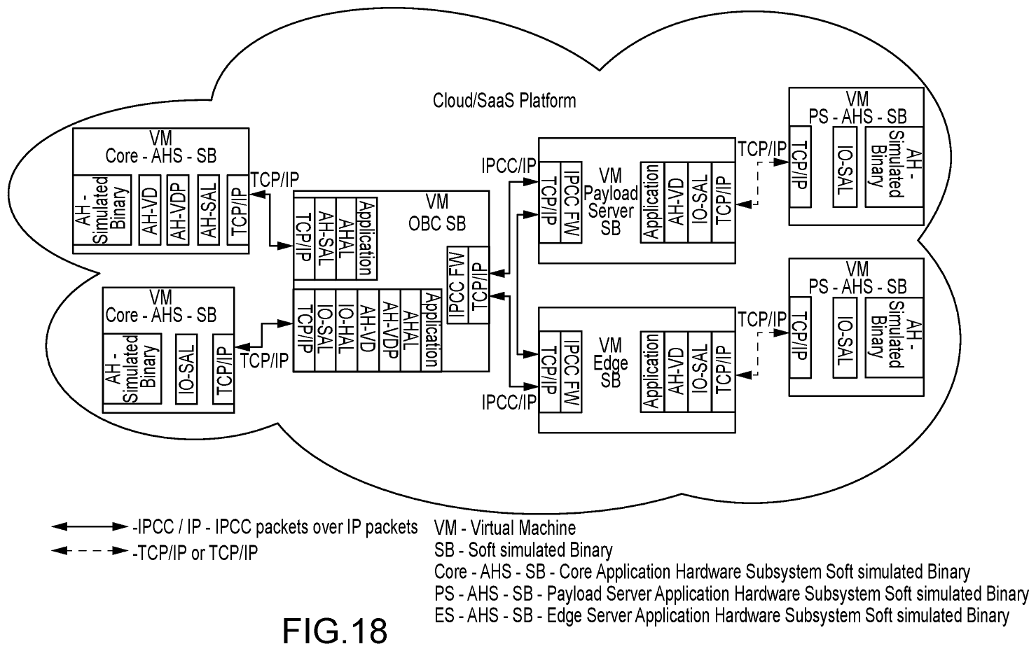

Turning to FIG. 18, a cloud platform is shown in accordance with embodiments of the present disclosure. The cloud platform includes a virtual machine soft simulated binary on-board control (which may be similar to or the same as the on-board controller 104), a virtual machine soft simulated binary payload server (which may be similar to or the same as the payload server 108), and a virtual machine soft simulated binary edge server (which may be similar to or the same as the edge server 112). The cloud platform may also include virtual machine soft simulated binary application hardware sub-systems (e.g., payload server AHS 116A-116N, edge server AHS 120A-120N, and/or core AHS 124A-124N). In other words, all the main computing nodes and all the application hardware sub-systems (e.g., sensors, application hardware, etc.) connected to the main computing nodes are soft simulated in the SaaS platform. In this environment, there is no remote simulation connected to the cloud platform.

For the connections between each of the soft simulated main computing hardware (e.g., on-board controller 104, the payload server 108, the edge server 112), IPCCFW may be used on top of an IP connection, with all connections being IP-based. In the full simulation mode, the on-board controller 104 may omit the use of physical IO drivers, and the IO-HAL may bridge the communication with the IPCCFW. The on-board controller 104 may communicate with the payload server 108 and/or the edge server 112 via IP communication without any physical IO drivers. The soft simulated on-board controller may include the IO-HAL and the IO-VDP API to provide TCP/IP socket interfaces that can be used to communicate with AHS as depicted, for example, in the call flow diagram of FIG. 13. The payload server 108 or the edge server 112 can either be a hardware platform or a simulated software platform that connects to other computing nodes running the SaaS platform.

The software may be under certain timing constraints or requirements to ensure that the hardware operates correctly. When the driver software tries to remotely interface with the hardware devices, there may be timing issues that arise. To address these issues, the IO-SAL and the AH-SAL APIs and the JSON schemas may be defined to account for the timing differences. For example, each IO-SAL API translation may specify the timing requirements of the current API (e.g., API 1) and a subsequent API (e.g., API 2) execution time. There may be different hardware interface timing requirements that can be addressed using the general schema introduced in the JSON file (or, more generally, any other readable file).

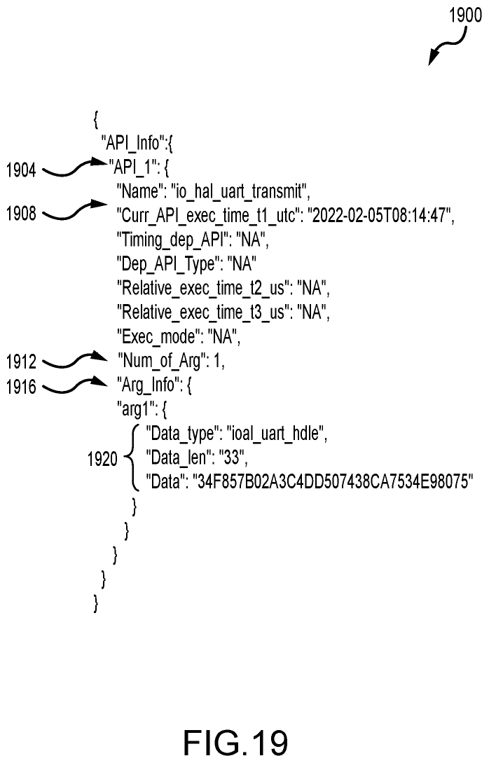

Turning to FIG. 19, aspects of a JSON template 1900 are shown in accordance with embodiments of the present disclosure. The JSON template depicted in FIG. 19 may provide a template for time-referenced API execution. For example, API 1 may be invoked at a first time at the remote node, with the first time being referenced to Coordinated Universal Time (UTC) or any other known time scheme. If the simulation running in the SaaS platform wanted the remote node to execute API 1 at the first time, then the IO-SAL and/or the AH-SAL would specify the first time as UTC time in the JSON file. The remote node can then time reference the API 1 execution accordingly. In some cases, such as when the remote node is connected to the Internet, the API 1 timing requirement may be synchronized with a local time or with a GMT/UTC server, such that the timing requirement is met when API 1 is executed.

As depicted in FIG. 19, the JSON template 1900 includes an API identifier 1904, an execution time 1908, a number of arguments 1912, argument information 1916, and argument values 1920. The API identifier 1904 may indicate which API is to be executed. The execution time 1908 indicates the time (e.g., in UTC) at which the API is to be executed on the remote node. The number of arguments 1912 may specify the number of arguments to be passed into the API, while the argument information 1916 specifies additional information about each argument to be passed into the API. The argument values 1920 may indicate the specific values that will be populated into the API. For instance, API 1 in FIG. 19 has a single argument (the number of arguments 1912 is equal to 1) and the argument information 1916 specifies the information for the single argument. The argument values 1920 indicate the data type, the data length, and the data itself that will be used when executing the API.

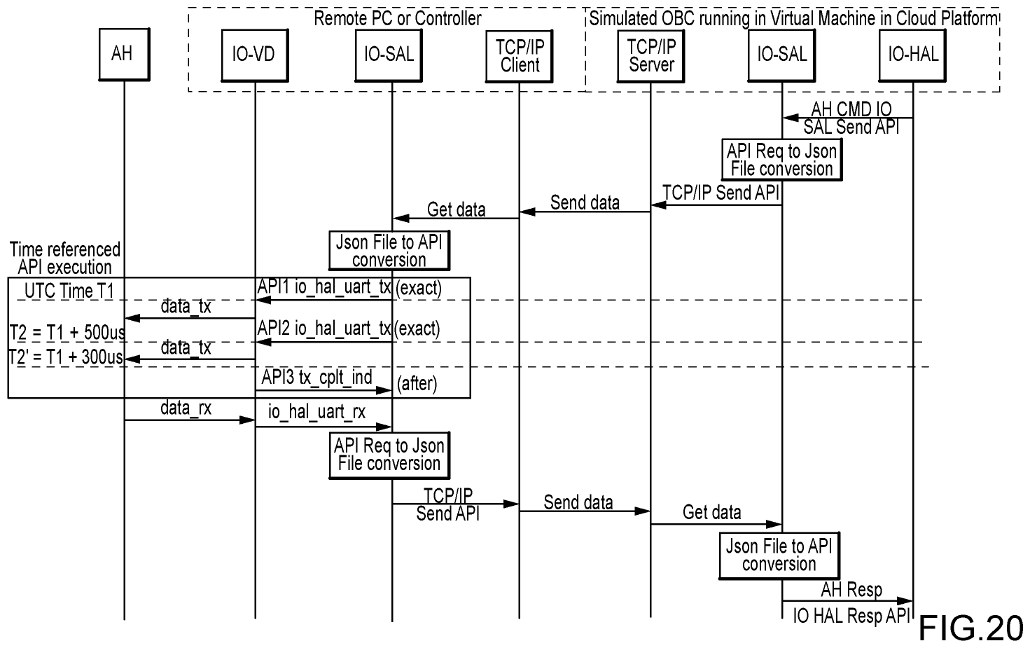

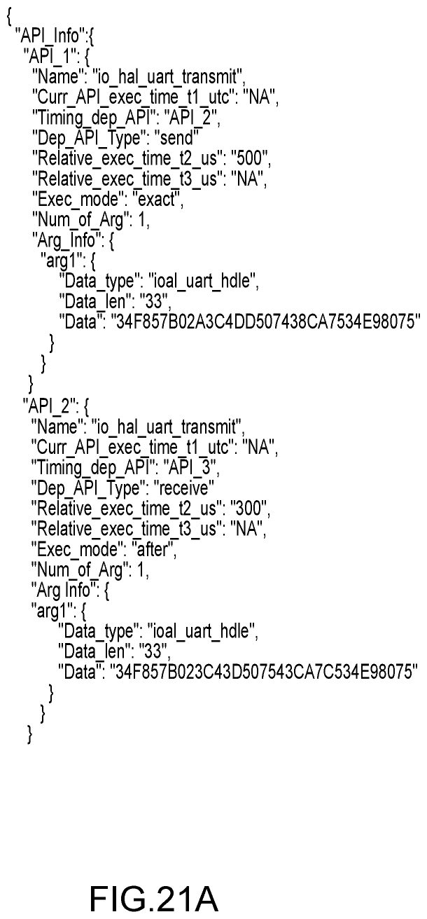

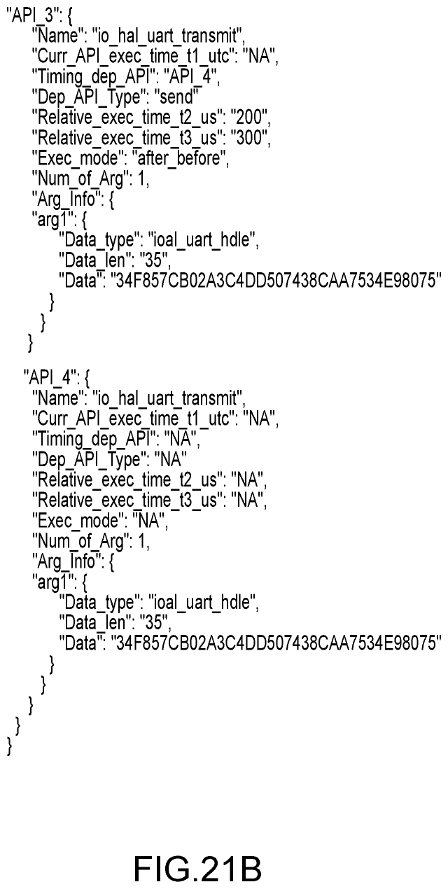

With reference to FIG. 20, a call flow diagram for time-referenced API execution is depicted according to at least one example embodiment of the present disclosure. In some examples, the call flow diagram of FIG. 20 may illustrate the execution of the JSON template of FIG. 19 or of the JSON template of FIGS. 21A-21B. The IO-HAL may send an API to the IO-SAL that specifies a command for the application hardware to take. The IO-SAL may then convert the API request to a JSON file, and send the data to a remote computer via a TCP/IP interface. The TCP/IP socket on the remote computer may forward the transmission to the IO-SAL in the remote computer, which may convert the JSON file to an API. Based on the information in the JSON file, which may contain timing constraints for API execution, the IO-SAL may specify that API 1 is to be executed at a first time, and that API 2 is to be executed at a second time after the first time (e.g., 500 microseconds after the first time). The IO-VD may then pass these commands to the application hardware such that the application hardware can execute the APIs at the required times. In some cases, the IO-VD may send a command for the application hardware to return the output data at some specified time after the second time (e.g., at a third time 300 microseconds after the second time). As a result, the application hardware may execute the APIs at the specified times, and wait until the third time to send the return data to the IO-VD. The IO-VD may pass the returned data to the IO-SAL, which converts the API request to a JSON file. The IO-SAL may then pass the JSON file via the TCP/IP socket to the IO-SAL on the on-board controller. The IO-SAL may then convert the JSON file to an API, which is then sent to the IO-HAL.

FIGS. 21A-21B depict aspects of a JSON template for time-referenced API executing according to at least one example embodiment of the present disclosure. The JSON template includes execution information for API 1, API 2, an API 3, and an API 4. The template may include relative execution timing for each of the APIs. For example, the JSON template specifies that the API 1 is dependent on the execution of API 2, which is dependent on the execution of API 3, which in turn is dependent on the execution of API 4. Alternatively, API 2 has a timing dependency on API 1, such as when API 1 is invoked at a first time then API 2 is to be invoked at a second time, where the difference in time (e.g., the second time minus the first time) is the time interval to be followed for the application hardware.

As another example, API 2 may have a timing dependency with API 1, such as when API 1 is invoked at a first time, and API 2 is to be invoked after a second time, where the time interval in between (e.g., the second time minus the first time) is the time interval minimally required to be followed before invoking API 2 for the application hardware to perform. Such an execution may be depicted by the call flow diagram of FIG. 20.

As yet another example, API 2 may have a timing dependency with API 1, such as when API 1 is invoked at a first time, then API 2 to be invoked after a second time but before a third time, where the time interval between the first time and the second time is minimally required to be followed before invoking API 2, and the API 2 is to be invoked before the third time minus the first time for the application hardware to perform.

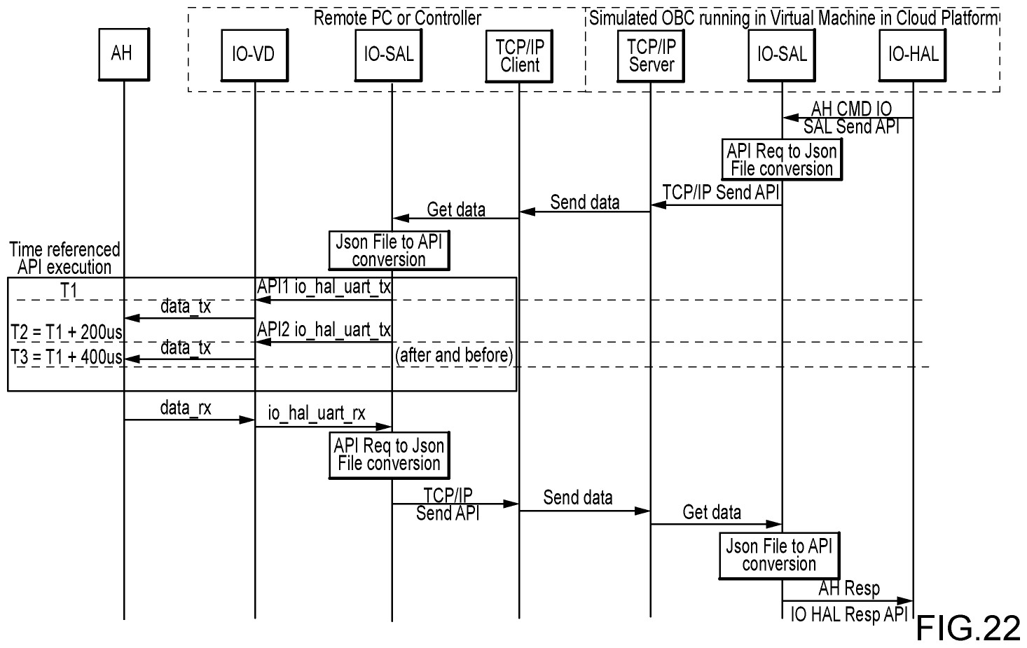

With reference to FIG. 22, a call flow diagram for time-referenced API execution is depicted according to at least one example embodiment of the present disclosure. The IO-HAL may send an API to the IO-SAL that specifies a command for the application hardware to take. The IO-SAL may then convert the API request to a JSON file, and send the data to a remote computer via a TCP/IP interface. The TCP/IP socket on the remote computer may forward the transmission to the IO-SAL in the remote computer, which may convert the JSON file to an API. Based on the information in the JSON file, which may contain timing constraints for API execution, the IO-SAL may specify that API 1 is to be executed at a first time, and that API 2 is to be executed at a second time after the first time (e.g., 200 microseconds after the first time) and before a third time after the second time (e.g., 400 microseconds after the first time). The TO-VD may then pass these commands to the application hardware such that the application hardware can execute the APIs at the required times. In some cases, the IO-VD may send a command for the application hardware to return the output data at some specified time after the third time. As a result, the application hardware may execute the APIs at the specified times, and wait until the specified time to send the return data to the IO-VD. The IO-VD may pass the returned data to the IO-SAL, which converts the API request to a JSON file. The IO-SAL may then pass the JSON file via the TCP/IP socket to the IO-SAL on the on-board controller. The IO-SAL may then convert the JSON file to an API, which is then sent to the IO-HAL.

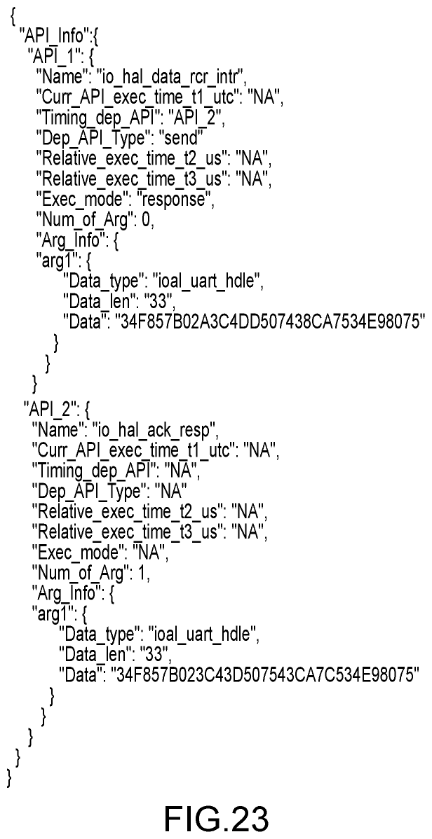

In some examples of timing requirements for API execution, the hardware may require immediate or time constrained acknowledgement or response from the software. In these examples, the IO-SAL/AH-SAL running in the SaaS platform can send an acknowledgement/response API ahead of time to the IO-SAL/AH-SAL running on the remote computer. The information sent may include the expected hardware event requiring the acknowledgement/response, and an API ID with the acknowledgement/response encoded in the JSON file with the timing constraints. As depicted in FIG. 23 for example, the API 1 information may specify that API 2 is to be executed as an acknowledgement in response to API 1 being executed, enabling the application hardware to operate as if the local software provided the acknowledgement (even though the acknowledgement was sent from the SaaS platform simultaneously with the command to execute the APIs).

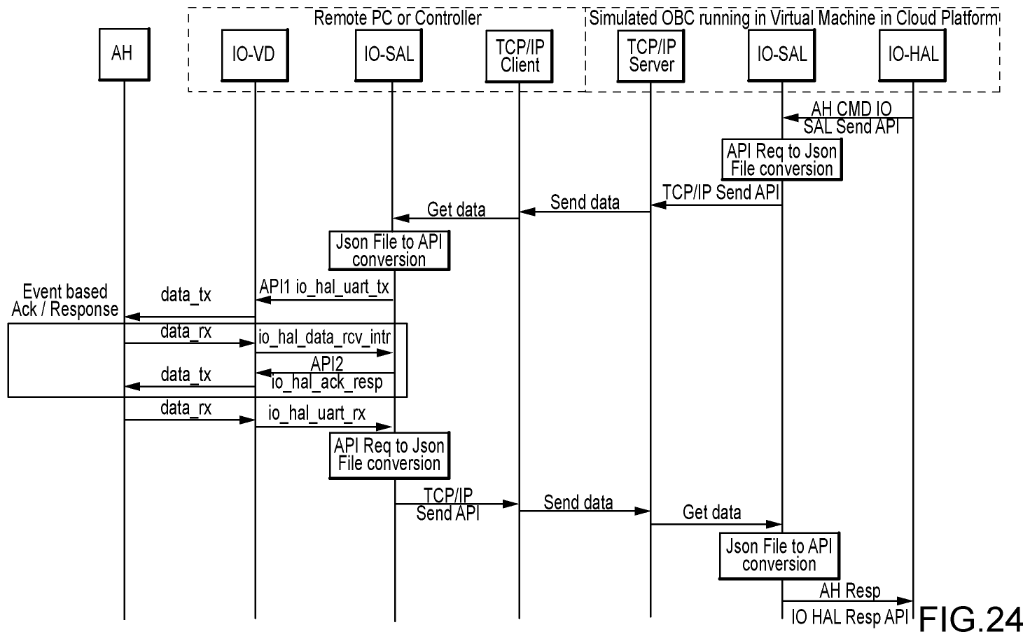

With reference to FIG. 24, a call flow diagram for time-referenced API execution is depicted according to at least one example embodiment of the present disclosure. In some cases, the call flow diagram of FIG. 24 may be executed when the application hardware requires an acknowledgement or response from the hardware, such as when the JSON file depicted in FIG. 23 is being executed. The IO-HAL may send an API to the IO-SAL that specifies a command for the application hardware to take. The IO-SAL may then convert the API request to a JSON file, and send the data to a remote computer via a TCP/IP interface. The TCP/IP socket on the remote computer may forward the transmission to the IO-SAL in the remote computer, which may convert the JSON file to an API. Based on the information in the JSON file, which may contain timing constraints for API execution, the IO-SAL may specify that API 1 is to be executed first and that API 2 is to be executed as an acknowledgement or response to the execution of API 1. The IO-VD may then pass a command to the application hardware to execute API 1. After API 1 is executed, the application hardware may generate data and an indicator of an expected acknowledgement or response from the software. For example, the application hardware may generate data indicating that the software is to acknowledge that the hardware has executed API 1. Upon receiving the hardware event/API, the IO-SAL/AH-SAL running on the remote computer may perform an immediate acknowledgement/response based on the determined acknowledgement/response information received in the JSON file. In some cases, the IO-SAL/AH-SAL may not process the data received from the application hardware, and may only look at the event ID and API ID and take appropriate actions. The data received from the hardware is then sent to the IO-SAL/AH-SAL running on the SaaS platform (e.g., via the TCP/IP socket after the API request has been converted to a JSON file). The IO-SAL/AH-SAL running on the SaaS platform may then process the data and further pass the data to the IO-HAL, where further action may be taken (e.g., the IO-HAL passed the data into the appropriate application running on the SaaS platform).

In some embodiments, API 1 and API 2 may both be sending APIs (e.g., an API that sends information to the application hardware), API 1 and API 2 may both be receiving APIs (e.g., an API that receives information from the application hardware), or one could be a sending API, while the other is a receiving API. In some cases, one or more APIs may be time-dependent on other APIs, and the APIs may be chained one after another in the respective order in the same JSON file at the sender side IO-SAL/AH-SAL. The receiving side IO-SAL/AH-SAL then handles the timing reference required to execute the APIs in the given order and given time reference. In some examples, the IO-SAL and/or the AH-SAL on the remote node/computer may be built with a timer-based sequencer and scheduler to handle the back to back and timing-dependent API executions.

In some cases, such as in a remote connectivity environment or a simulation environment, network transfer latency may be estimated and pre-configured in the IO-SAL and AH-SAL, or may be dynamically monitored and measured by the SaaS platform and dynamically configured/changed. If the network latency is configured to be greater than or equal to the timing requirements (e.g., the latency is greater than or equal to the difference between the second time at which API 2 is executed and the first time at which API 1 is executed), then the IO-SAL and/or AH-SAL running on the SaaS platform may sequence the timing dependent APIs in a single JSON file with the required timing details and expect the IO-SAL and/or AH-SAL running in the remote node/computer to handle the timing constraints required to run the APIs locally interfacing with the application hardware. If the network latency is configured to be less than the timing requirements (e.g., the latency is less than the difference between the second time at which API 2 is executed and the first time at which API 1 is executed), the network latency may be treated as being in a safe latency zone, and if the timing requirement can be met by remotely sequencing the APIs from the SaaS platform, then the IO-SAL and/or the AH-SAL running on the SaaS platform may maintain and manage the timing reference for the APIs. The IO-SAL and/or the AH-SAL running on the SaaS platform may sequence the APIs from the SaaS platform itself. In other words, the lack of network latency may enable the APIs to be managed without needing to send a single JSON file and expect the local SAL to manage the timing requirement. In other examples, a user may be able to configure the SaaS platform such that the timing requirements are satisfied. In some cases, the delivery of the JSON files may be done asynchronously (e.g., the first request in a first JSON file is delivered at a first time, and the second request in a second JSON file is delivered later). In other cases, the JSON files may be done synchronously.

The SaaS and/or cloud platforms discussed herein may be configured to permit multiple users (e.g., a primary user, a secondary user, etc.) to access the SaaS and/or cloud platform. For a multi user connection with the SaaS platform, the nodes may be peer-to-peer and real-time (or near real-time) connections. The real time interactions and peer-to-peer connectivity requirements between the nodes may use peer-to-peer TCP/IP or UDP/IP socket connections. The SaaS platform may enable the user to login (e.g., to a remote node and/or direct on to the SaaS platform), and for each user session an IP session may be maintained for connection.

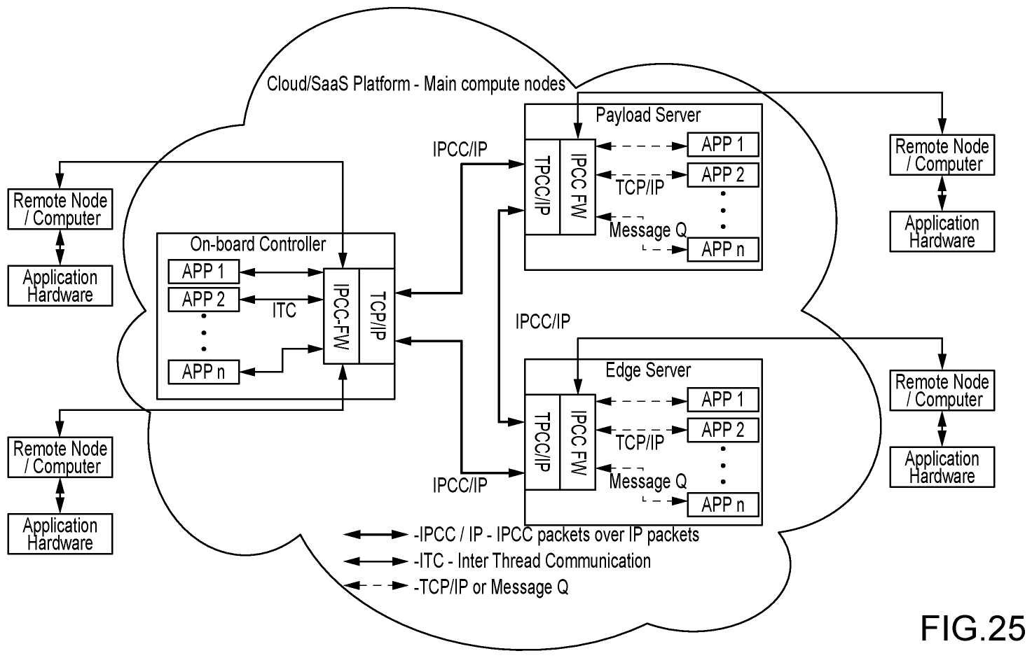

FIG. 25 depicts a system for multi-user access to a cloud/SaaS platform according to embodiments of the present disclosure. In some examples, the multi-user access platform may include the components of system 100 (e.g., the on-board controller 104, the payload server 108, the edge server 112, the payload server AHS 116A-116N, etc.). In the multi-user access platform, one or more users may connect remotely, and each user may try to connect a remote node/computer to the SaaS platform for driver integration or for simulation for a given FlatSat simulation in the SaaS platform. The remote node/computer may include an AHS. The SaaS platform may enable each user to connect to various computing nodes on the SaaS platform, with the SaaS platform containing a single simulation (e.g., a single virtual copy of the on-board controller 104, a single virtual copy of the payload server 108, and a single virtual copy of the edge server 112).

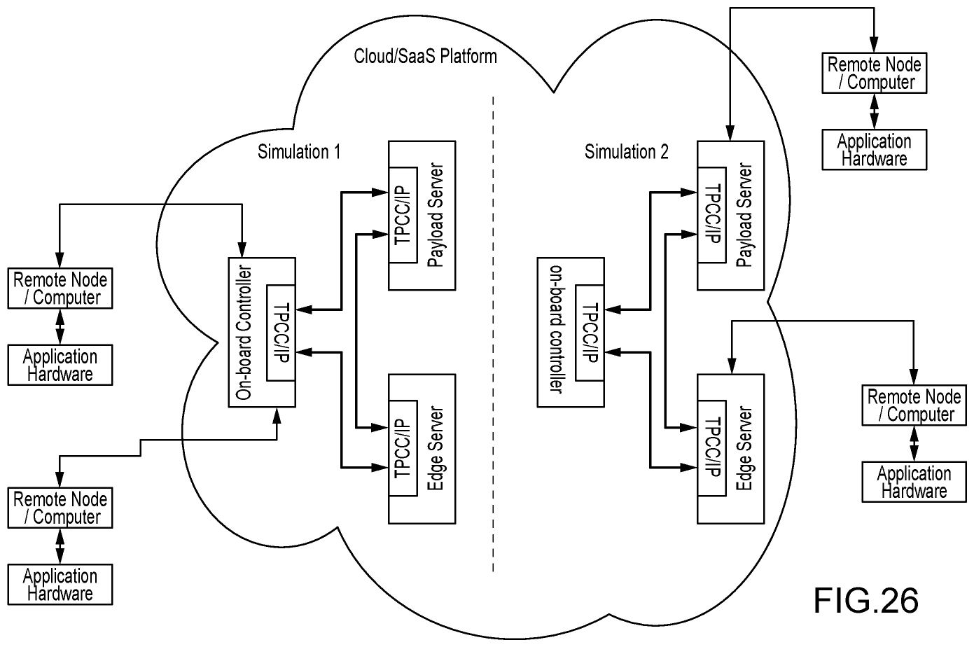

FIG. 26 depicts another system for multi-user access to a cloud/SaaS platform according to embodiments of the present disclosure. In some examples, the multi-user access platform may include the components of system 100 (e.g., the on-board controller 104, the payload server 108, the edge server 112, the payload server AHS 116A-116N, etc.). Unlike the model in FIG. 25, the multi-user access configuration of FIG. 26 enables multiple users to access different FlatSat builds/simulations within the SaaS platform. In other words, the SaaS platform may build a first simulation for a first user (e.g., a primary user), and may build a second simulation for a second user (e.g., a secondary user). In some cases, the first and second simulations may be identical, while in other examples the SaaS platform may provide different computing nodes to different users.

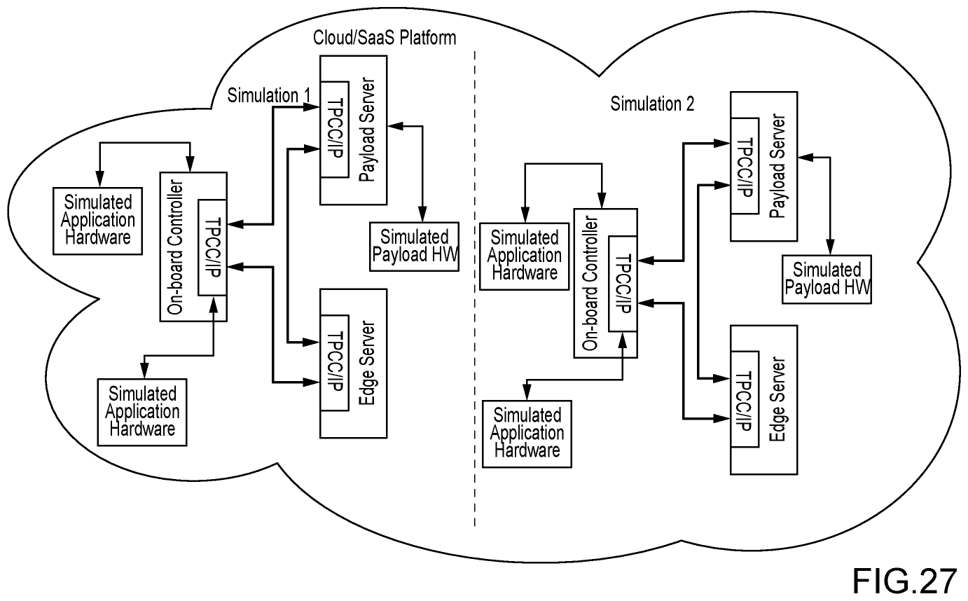

FIG. 27 depicts yet another system for multi-user access to a cloud/SaaS platform according to embodiments of the present disclosure. In some examples, the multi-user access platform may include the components of system 100 (e.g., the on-board controller 104, the payload server 108, the edge server 112, the payload server AHS 116A-116N, etc.). The SaaS platform may include simulated application hardware within the cloud architecture, such that the users do not need to connect remote nodes/computers to the SaaS platform. In such an environment, the user may login and access different FlatSat builds and/or simulations without needing to connect local computers and/or AHS to the SaaS platform.

Any of the steps, functions, and operations discussed herein can be performed continuously and automatically.

The exemplary systems and methods of this disclosure have been described in relation to a virtual FlatSat. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub-combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

What is claimed is:

1. A system, comprising:
three or more distributed computes that interact with one another in a cloud environment and at least one of which is in communication with a remote resource via a cloud connection, wherein each of the three or more distributed computes are configured to receive information from the remote resource and/or provide commands executable by the remote resource.

2. The system of claim 1, wherein the remote resource comprises a simulated resource.

3. The system of claim 2, wherein the simulated resource comprises a simulated sensor.

4. The system of claim 3, wherein the simulated sensor comprises a sensor configured for use on a satellite.

5. The system of claim 2, wherein the simulated resource comprises at least one of simulated software, simulated hardware, and a simulated compute node.

6. The system of claim 1, wherein the cloud environment is executed on a satellite.

7. The system of claim 1, wherein the cloud environment is executed on a terrestrial server.

8. The system of claim 1, wherein at least one of the three or more distributed computes are virtualized.

9. The system of claim 8, wherein all of the three or more distributed computes are virtualized.

10. The system of claim 1, wherein the three or more distributed computes comprise at least one of a micro controller, a micro-processor, a payload server, and an edge server.

11. The system of claim 1, wherein communication with the remote resource is facilitated by at least one of a physical input output hardware abstraction layer (IO-HAL) and an application hardware abstraction layer (AHAL).

12. The system of claim 11, wherein the IO-HAL comprises an abstracted physical communication interface.

13. The system of claim 11, wherein the AHAL comprises an abstracted application layer of a physical communication interface.

14. The system of claim 1, wherein the communication with the remote resource is facilitated by transmitting one or more JSON files.

15. The system of claim 14, wherein the one or more JSON files define at least one of a current API execution time, a timing dependent API, a relative execution time, an execution mode, and a number of arguments.

16. The system of claim 15, wherein the one or more JSON files are converted into one or more API calls.

17. A system for a satellite, comprising:
at least one resource that communicates with a payload of the satellite, the at least one resource including a first abstracted physical communication interface; and
a controller coupled to the at least one resource and including a second abstracted physical communication interface that communicates with the first abstracted physical communication interface over a communications link.

18. The system of claim 17, wherein the communications link comprises a USB connection, a UART connection, an Ethernet connection, an SPI connection, a PCI connection, a physical interface, a wireless interface, and/or an I2C connection.

19. The system of claim 17, wherein the at least one resource includes a payload server, an edge server, a compute resource, and/or a compute node.

20. The system of claim 19, wherein the compute node is a client node or a server node.
